(19) United States
(12) Patent Application Publication
(10) Pub. No.: US 2026/0075571 A1
(43) Pub. Date: Mar. 12, 2026

(54) POSITIONING METHOD AND NETWORK DEVICE

(71) Applicant: GUANGDONG OPPO MOBILE TELECOMMUNICATIONS CORP., LTD., Dongguan (CN)

(72) Inventor: Yang LIU, Dongguan (CN)

(21) Appl. No.: 19/387,574

(22) Filed: Nov. 12, 2025

Related U.S. Application Data
(63) Continuation of application No. PCT/CN2023/109939, filed on Jul. 28, 2023.

(51) Int. Cl. H04W 64/00; H04W 72/25; H04W 76/40

(52) U.S. Cl. CPC H04W 64/00; H04W 72/25; H04W 76/40

(57) ABSTRACT

Provided are a positioning method and a network device. The positioning method is performed by a first terminal device and the method includes transmitting first information, wherein the first information is used to indicate an entry of the first terminal device into a first area or to request to activate and use first configuration information; and transmitting a sidelink positioning reference signal (SL-PRS) based on the first configuration information, or performing measurement on an SL-PRS from a second terminal device based on the first configuration information; wherein the first configuration information is associated with the first area.

### CROSS-REFERENCE TO RELATED APPLICATION

This application is a continuation of International Application No. PCT/CN2023/109939, filed Jul. 28, 2023, the entire disclosure of which is incorporated herein by reference.

### TECHNICAL FIELD

The present disclosure relates to the field of communications, and in particular, relates to a positioning method and a network device.

### RELATED ART

Different from conventional mobile communication systems where positioning methods rely on a terminal-to-network communication, a sidelink (SL) positioning is implemented via reference signals (RSs) between terminal devices. In response to a trigger of the SL positioning, a first terminal device with positioning requirements first discovers a qualified second terminal device based on a configuration from a network device or measurement of a surrounding signal by the first terminal device. Subsequently, a measurement result of an RS is obtained via measurement, by the first terminal device, of an RS from the second terminal device and/or via measurement, by the second terminal device, of an RS from the first terminal device, thereby obtaining a positioning result of the first terminal device.

### SUMMARY

Embodiments of the present disclosure provide a positioning method and a network device. The technical solutions are as follows:

According to some embodiments of the present disclosure, a positioning method is provided. The method is performed by a first terminal device, and includes:
transmitting first information, wherein the first information is used to indicate an entry of the first terminal device into a first area or to request activate and use first configuration information; and
transmitting an SL positioning RS (SL-PRS) based on the first configuration information, or performing measurement on an SL-PRS from a second terminal device based on the first configuration information;
wherein the first configuration information is associated with the first area.

According to some embodiments of the present disclosure, a network device is provided. The network device includes:
a processor, a transceiver communicably connected to the processor, and a memory, configured to store one or more instructions executable by the processor, wherein the processor is configured to load and execute the one or more instructions to cause the network device to: receive first information from a first terminal device, wherein the first information is used to indicate an entry of the first terminal device into a first area or to request to activate and use first configuration information;
wherein the first area is associated with the first configuration information.

According to some embodiments of the present disclosure, a positioning method is provided. The method is performed by a second terminal device, and includes:
receiving trigger information, wherein the trigger information is used to trigger the second terminal device to perform at least one of: initiating transmission of an SL-PRS, initiating reception of an SL-PRS, or initiating measurement on an SL-PRS;
wherein the SL-PRS is transmitted based on first configuration information.

### BRIEF DESCRIPTION OF DRAWINGS

For clearer illustration of the technical solutions according to the embodiments of the present disclosure, the drawings required in the description of the embodiments are described hereinafter briefly. Obviously, the drawings described herein are only some of the embodiments of the present disclosure. A person of ordinary skill in the art may derive other drawings based on these drawings without any creative efforts.

FIG. 1 is a schematic diagram of an SL communication scenario according to some exemplary embodiments of the present disclosure;

FIG. 2 is a schematic diagram of an SL communication scenario according to some exemplary embodiments of the present disclosure;

FIG. 3 is a schematic diagram of an SL communication scenario according to some exemplary embodiments of the present disclosure;

FIG. 4 is a schematic flowchart of a positioning method according to some exemplary embodiments of the present disclosure;

FIG. 5 is a schematic flowchart of a positioning method according to some exemplary embodiments of the present disclosure;

FIG. 6 is a schematic diagram of a mobile communication system according to some exemplary embodiments of the present disclosure;

FIG. 7 is a schematic flowchart of a positioning method according to some exemplary embodiments of the present disclosure;

FIG. 8 is a schematic flowchart of a positioning method according to some exemplary embodiments of the present disclosure;

FIG. 9 is a schematic flowchart of a positioning method according to some exemplary embodiments of the present disclosure;

FIG. 10 is a schematic flowchart of a positioning method according to some exemplary embodiments of the present disclosure;

FIG. 11 is a schematic flowchart of a positioning method according to some exemplary embodiments of the present disclosure;

FIG. 12 is a schematic flowchart of a positioning method according to some exemplary embodiments of the present disclosure;

FIG. 13 is a schematic flowchart of a positioning method according to some exemplary embodiments of the present disclosure;

FIG. 14 is a schematic diagram of a positioning method according to some exemplary embodiments of the present disclosure;

FIG. 15 is a structural block diagram of a positioning apparatus according to some exemplary embodiments of the present disclosure;

FIG. 16 is a structural block diagram of a positioning apparatus according to some exemplary embodiments of the present disclosure;

FIG. 17 is a structural block diagram of a positioning apparatus according to some exemplary embodiments of the present disclosure; and

FIG. 18 is a schematic structural diagram of a communication device according to some exemplary embodiments of the present disclosure.

### DETAILED DESCRIPTION

For clearer descriptions of the objectives, technical solutions, and advantages of the present disclosure, some embodiments of the present disclosure are described in detail hereinafter with reference to the accompanying drawings. The exemplary embodiments are described in detail herein, and their examples are illustrated in the accompanying drawings. When the following description refers to the accompanying drawings, the same numerals in different accompanying drawings represent the same or similar elements, unless otherwise indicated. The embodiments described in the following exemplary embodiments do not represent all embodiments consistent with the present disclosure. Rather, these embodiments are merely examples of devices and methods consistent with some aspects of the present disclosure, as detailed in the appended claims.

The terms used in the present disclosure are solely for the purpose of describing specific embodiments and are not intended to limit the present disclosure. As used in the present disclosure and the appended claims, the singular forms “a,” “an,” and “the” are also intended to include their plural forms, unless the context clearly indicates otherwise. It should also be understood that the term “and/or” as used herein refers to and encompasses any or all possible combinations of one or more of associated listed items.

It should be understood that although the terms “first,” “second,” “third,” and the like may be used herein to describe various types of information, and such information should not be limited by these terms. These terms are only used to distinguish one type of information from another. For example, first information may also be referred to as second information, and similarly, second information may also be referred to as first information, without departing from the scope of the present disclosure. The phrase “in a case where,” as used herein, may be interpreted as “when,” “upon,” or “in response to determining that,” depending on the context.

First, related technologies involved in the embodiments of the present disclosure are described hereinafter.

### SL Communication

An SL refers to a direct communication link between devices. Different from conventional mobile communication systems where network-to-terminal signal reception and transmission are performed, the SL transmission refers to a communication mode where signal reception and transmission are directly performed between terminal devices over an SL. The SL transmission has characteristics such as low delay, or minimal overhead, and is particularly suitable for communication between two terminals that are geographically close to each other (e.g., between a vehicle-mounted device and another surrounding device geographically close to the vehicle-mounted device). The SL technology is applicable to various scenarios where terminal devices directly communicate with each other. That is, the terminal device in the present disclosure refers to any device utilizing the SL technology for communication.

In the SL transmission, based on a network coverage status of a terminal device, the communication may be divided into SL communication within network coverage (or referred to as in-coverage SL communication), SL communication partially within network coverage (or referred to as partial-coverage SL communication), and SL communication out of network coverage (or referred to as out-of-coverage SL communication), which are respectively illustrated in FIGS. 1, 2, and 3.

As illustrated in FIG. 1, in an in-coverage SL communication scenario, all of terminal devices 21 engaged in the SL communication are within the coverage of the same network device (a network device 10). Thus, these terminal devices 21 are capable of receiving configuration signaling from the network device 10 and perform the SL communication based on the same SL configuration.

As illustrated in FIG. 2, in a partial-coverage SL communication scenario, part of terminal devices (e.g., a terminal device 21) engaged in the SL communication is within the coverage of a network device. This part of terminal devices (e.g., the terminal device 21) is capable of receiving configuration signaling from a network device 10 and performing the SL communication based on the configuration from the network device 10. However, terminal devices (e.g., a terminal device 22) out of the network coverage is incapable of receiving the configuration signaling from the network device 10. In this case, the terminal device 22 out of the network coverage may determine an SL configuration based on pre-configuration information and/or information carried in a physical sidelink broadcast channel (PSBCH) from the terminal device 21, to perform the SL communication.

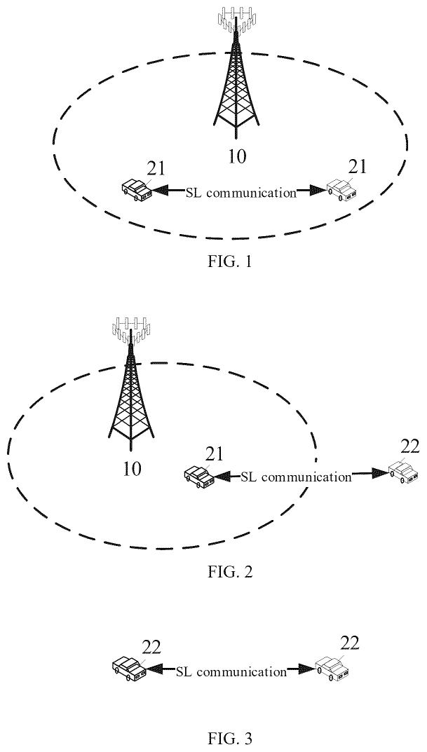

As illustrated in FIG. 3, in an out-of-coverage SL communication scenario, all of terminal devices 22 engaged in the SL communication are out of the network coverage, and all of the terminal devices 22 may determine an SL configuration based on pre-configuration information, to perform the SL communication.

### SL Positioning

Different from conventional mobile communication systems where positioning methods rely on a terminal-to-network communication, the SL positioning is implemented via RSs between terminal devices.

In an SL positioning method, an RS is transmitted and measured in a designated frequency band over an SL. A measurement result of the RS may reflect positioning reference variables with practical physical significance in space, such as a relative distance and a relative angle between terminal devices. In response to a trigger of the SL positioning, a first terminal device with positioning requirements first discovers a qualified second terminal device based on a configuration from a network device or measurement of a surrounding signal by the first terminal device. Subsequently, a measurement result of an RS is obtained via measurement, by the first terminal device, of an RS from the second terminal device and/or via measurement, by the second terminal device, of an RS from the first terminal device, thereby obtaining a positioning result of the first terminal device.

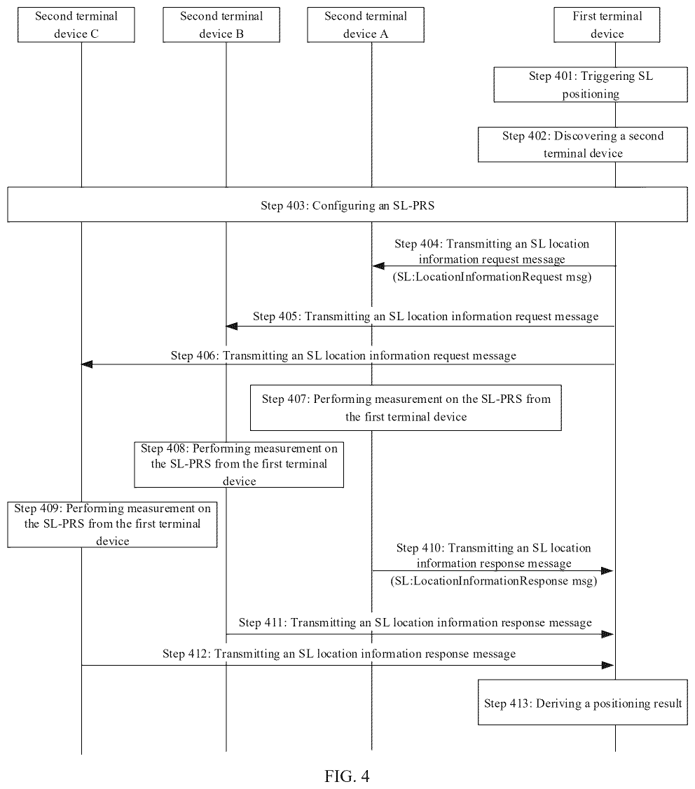

In a case where the second terminal device performs the measurement on the RS from the first terminal device, an SL positioning procedure is illustrated in FIG. 4 by using an example where the second terminal device includes a second terminal device A, a second terminal device B, and a second terminal device C.

In step 401, the first terminal device triggers SL positioning (or called the first terminal device initiates triggering of positioning need).

In some embodiments, in a case where the first terminal device has a positioning requirement, the first terminal device autonomously triggers the SL positioning, or autonomously triggers initiation of the SL positioning procedure.

In some embodiments, the first terminal device receives trigger information for SL positioning; and the first terminal device triggers the SL positioning based on the trigger information for SL positioning, or triggers the initiation of the SL positioning procedure based on the trigger information for SL positioning.

In step 402, the first terminal device discovers the second terminal device (or called the first terminal device finds qualified anchor user equipments (UEs)).

The second terminal device is configured to assist in positioning the first terminal device. The second terminal device is also referred to as an assisting positioning device, an assisting terminal device, or an anchor UE.

In some embodiments, the first terminal device discovers the second terminal device based on a configuration from the network device.

In some embodiments, the first terminal device performs measurement on a surrounding signal, and discovers the second terminal device based on a measurement result of the surrounding signal.

Exemplarily, the second terminal device includes a terminal device B1, a terminal device B2, and a terminal device B3.

In step 403, an SL-PRS is configured.

The SL-PRS is configured between the first terminal device and the second terminal device A, the second terminal device B, and the second terminal device C.

In step 404, the first terminal device transmits an SL location information request message (e.g., an SL Location Information Request MSG, or an SL:LocationInformationRequest msg) to the second terminal device A.

In step 405, the first terminal device transmits an SL location information request message to the second terminal device B.

In step 406, the first terminal device transmits an SL location information request message to the second terminal device C.

In step 407, the second terminal device A performs measurement on the SL-PRS from the first terminal device.

In step 408, the second terminal device B performs measurement on the SL-PRS from the first terminal device.

In step 409, the second terminal device C perform measurement on the SL-PRS from the first terminal device.

In step 410, the second terminal device A transmits an SL location information response message (e.g., an SL Location Information Response MSG, or an SL:LocationInformationResponse msg) to the first terminal device.

In step 411, the second terminal device B transmits an SL location information response message to the first terminal device.

In step 412, the second terminal device C transmits an SL location information response message to the first terminal device.

In step 413, the first terminal device derives a positioning result.

The first terminal device obtains the positioning result of the first terminal device based on the SL location information response messages fed back by the second terminal device A, the second terminal device B, and the second terminal device C.

It should be understood that the execution order of the above steps may be adjusted according to specific circumstances. For example, step 407 is performed after step 404, and step 410 is performed after step 407. For another example, step 408 is performed after step 405, and step 411 is performed after step 408. For yet another example, step 409 is performed after step 406, and step 412 is performed after step 409.

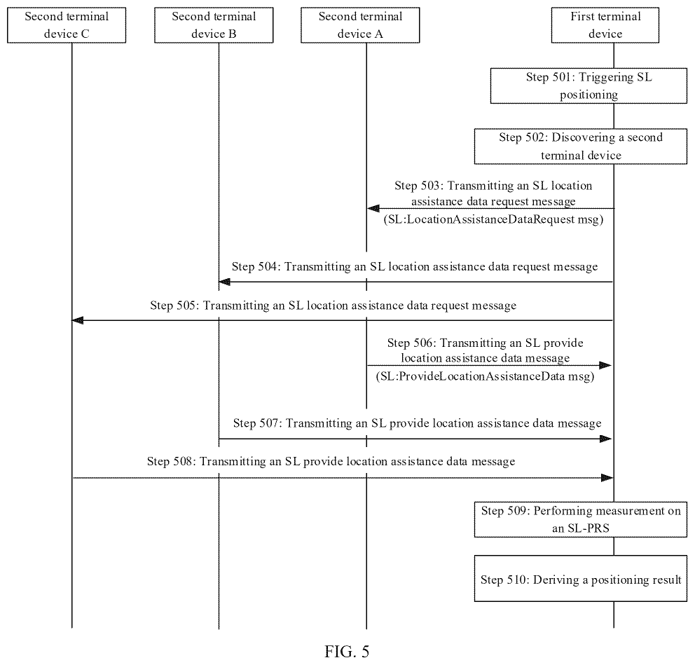

In a case where the first terminal device performs measurement on the RS from the second terminal device, an SL positioning procedure is illustrated in FIG. 5 by using an example where the second terminal device includes a second terminal device A, a second terminal device B, and a second terminal device C.

In step 501, the first terminal device triggers SL positioning.

In some embodiments, in a case where the first terminal device has a positioning requirement, the first terminal device autonomously triggers the SL positioning, or autonomously triggers initiation of the SL positioning procedure.

In some embodiments, the first terminal device receives trigger information for SL positioning; and the first terminal device triggers the SL positioning based on the trigger information for SL positioning, or triggers the initiation of the SL positioning procedure based on the trigger information for SL positioning.

In step 502, the first terminal device discovers the second terminal device.

In some embodiments, the first terminal device discovers the second terminal device based on a configuration from the network device.

In some embodiments, the first terminal device performs measurement on a surrounding signal, and discovers the second terminal device based on a measurement result of the surrounding signal.

Exemplarily, the second terminal device includes a terminal device B1, a terminal device B2, and a terminal device B3.

In step 503, the first terminal device transmits an SL location assistance data request message (e.g., an SL Location Assistance Data Request MSG, or an SL:LocationAssistanceDataRequest msg) to the second terminal device A.

In step 504, the first terminal device transmits an SL location assistance data request message to the second terminal device B.

In step 505, the first terminal device transmits an SL location assistance data request message to the second terminal device C.

In step 506, the second terminal device A transmits an SL provide location assistance data message (e.g., an SL Provide Location Assistance Data MSG or an SL:ProvideLocationAssistanceData msg) to the first terminal device.

In step 507, the second terminal device B transmits an SL provide location assistance data message to the first terminal device.

In step 508, the second terminal device C transmits an SL provide location assistance data message to the first terminal device.

In step 509, the first terminal device performs measurement on an SL-PRS.

In step 510, the first terminal device derives a positioning result.

The first terminal device obtains the positioning result of the first terminal device based on a measurement result of the SL-PRS.

It should be understood that the execution order of the above steps may be adjusted according to specific circumstances. For example, step 506 is performed after step 503, and step 507 is performed after step 504. For another example, step 508 is performed after step 505.

However, in a case where the first terminal device employing the above SL positioning procedure crosses areas, the network device may fail to recognize the cross-area behavior of the terminal device, which may result in delays in initiating transmission, reception, or measurement of the SL-PRS by the second terminal device in a corresponding area, thereby adversely affecting the positioning efficiency and the accuracy of the positioning result.

In view of the above problems, the present disclosure provides a positioning method, which supports timely transmission and reception of the SL-PRS between the first terminal device and the second terminal device in a scenario where the first terminal device exhibits the cross-area behavior, thereby improving the positioning efficiency.

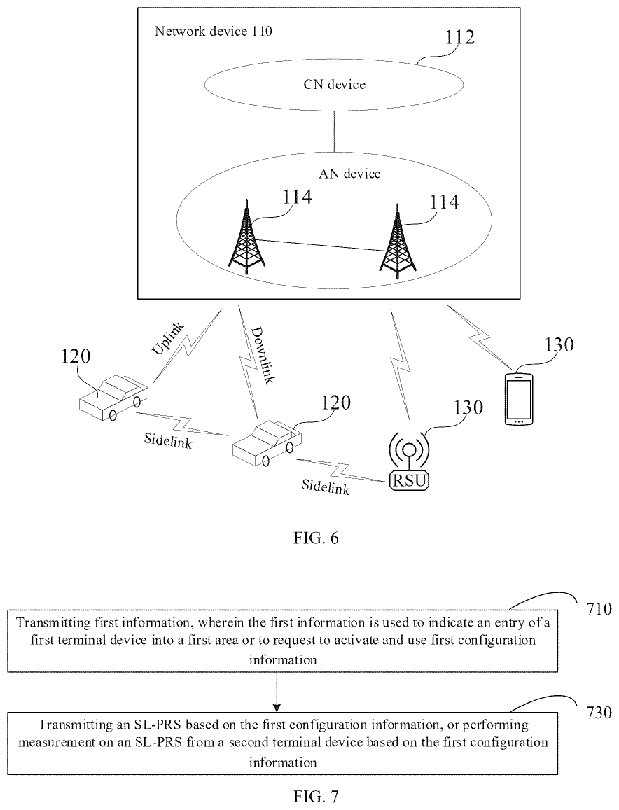

FIG. 6 is a schematic diagram of a mobile communication system according to some exemplary embodiments of the present disclosure. The mobile communication system includes a network device 110 and terminal devices (including a terminal device 120 and a terminal device 130). This is not limited in the present disclosure.

The network device 110 in the present disclosure provides a wireless communication function, and the network device 110 includes, but is not limited to: an evolved Node-B (eNB), a radio network controller (RNC), a Node-B (NB), a base station controller (BSC), a base transceiver station (BTS), a home base station (e.g., a home evolved Node-B or a home Node-B (HNB)), a baseband unit (BBU), an access point (AP) in a wireless fidelity (Wi-Fi) system, a wireless relay node, a wireless backhaul node, a transmission point (TP), a transmission and reception point (TRP), or the like. The network device may also be a next generation Node-B (gNB) or a transmission point (TRP or TP) in a 5^{th}-generation (5G) mobile communication system; or may be an antenna panel or a group of antenna panels (including a plurality of antenna panels) in a 5G system; or may also be a network node constituting a gNB or a transmission point, e.g., a BBU or a distributed unit (DU); or a base station or the like in a beyond-fifth generation (B5G) mobile communication system or a 6^{th}-generation (6G) mobile communication system; or a core network (CN), fronthaul, backhaul, a radio access network (RAN), or a network slice; or a serving cell, a primary cell (PCell), a primary secondary cell (PSCell), a special cell (SpCell), a secondary cell (SCell), a neighbor cell, or the like of a terminal device.

In some embodiments, the network device 110 includes a CN device 112 and/or an access network (AN) device 114.

The CN device 112 mainly functions to provide user connections, user management, and service bearing, and serves as a bearer network to provide an interface to an external network. Exemplarily, the CN device 112 includes an access and mobility management function (AMF) entity, a user plane function (UPF) entity, a session management function (SMF) entity, a location management function (LMF) entity, or the like. The CN device 112 is deployed in a CN.

The AN device 114 refers to a device deployed in an AN to provide a wireless communication function for the terminal device 120. The AN device 114 may include various forms of macro base stations, micro base stations, relay stations, access points, or the like. In systems using different radio access technologies, a device with the function of an AN device may have different names. For example, in a 5G new radio (NR) system, the AN device 114 is referred to as a 5G base station (e.g., a next generation Node-B (abbreviated as gNodeB or gNB)). As communication technologies evolve, the name “AN device” may change. For convenience of description, in the embodiments of the present disclosure, the above devices for providing the terminal device 120 with the wireless communication function are collectively referred to as AN devices 114.

One or more terminal devices 120 may be provided, and one or more terminal devices 130 may be provided. One or more terminal devices may be distributed in a cell managed by each AN device 114.

In the present disclosure, the terminal device is also referred to as a UE, an access terminal, a subscriber unit, a subscriber station, a mobile station, a remote station, a remote terminal, a mobile device, a user terminal, a terminal, a wireless communication device, a user agent, or a user device. The terminal includes but is not limited to: a handheld device, a wearable device, a vehicle-mounted device, an Internet of things (IoT) device, or the like, such as a mobile phone, a tablet computer, a road side unit (RSU), an e-book reader, a laptop portable computer, a desktop computer, a TV, a game console, a mobile Internet device (MID), an augmented reality (AR) terminal, a virtual reality (VR) terminal, and a mixed reality (MR) terminal, an extended reality (XR) terminal, a baffle reality (BR) terminal, a cinematic reality (CR) terminal, a deceive reality (DR) terminal, a wearable device, a handle, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in a smart home, a wireless terminal in remote medical surgery, a cellular phone, a cordless phone, a Session Initiation Protocol (SIP) phone, a wireless local loop (WLL) station, a personal digital assistant (PDA), a set-top box (STB), a customer premise equipment (CPE), a sensor, a monitoring device, or the like.

In some embodiments, the AN device 114 and the CN device 112 communicate with each other via an air interface technology, such as an NG interface in a 5G NR system.

In some embodiments, the AN device 114 and the terminal device 120 communicate with each other via an air interface technology, such as a Uu interface.

In some embodiments, the AN device 114 and the terminal device 130 communicate with each other via an air technology, such as a Uu interface.

Exemplarily, two types of communication scenarios are present between the network device 110 and the terminal device 120, namely, an uplink communication scenario and a downlink communication scenario. The uplink communication, also referred to as uplink transmission, refers to signal or data transmission to the network device 110. The downlink communication, also referred to as downlink transmission, refers to signal or data transmission to the terminal device 120.

The terminal device 120 and the terminal device 130 may communicate with each other via an SL communication interface (e.g., a PC5 interface). For example, a vehicle-mounted device communicates with another device (e.g., another vehicle-mounted device, a mobile phone, or an RSU) via the PC5 interface. Accordingly, the communication link established based on the SL communication interface may be referred to as an SL.

The terminal device 120 and the terminal device 130 are both within network coverage and located in the same cell, or the terminal device 120 and the terminal device 130 are both within network coverage but located in different cells, or the terminal device 120 is within network coverage, but the terminal device 130 is out of network coverage.

The technical solutions according to the embodiments of the present disclosure are applicable to various communication systems, such as a global system of mobile communication (GSM) system, a code-division multiple access (CDMA) system, a wideband code-division multiple access (WCDMA) system, a general packet radio service (GPRS), a long-term evolution (LTE) system, a frequency-division duplex (FDD) system, a time-division duplex (TDD) system, an advanced long-term evolution (LTE-A) system, a universal mobile telecommunication system (UMTS), a worldwide interoperability for microwave access (WiMAX) communication system, a 5G mobile communication system, an NR system, an evolved system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN), a Wi-Fi system, a cellular IoT system, or a cellular passive IoT system. The technical solutions according to the embodiments of the present disclosure are also applicable to a subsequent evolved system of a 5G NR system, and further applicable to a B5G system, a 6G system, and a subsequent evolved system. In some embodiments of the present disclosure, “NR” may also be referred to as a 5G NR system or a 5G system. The 5G mobile communication system includes a non-standalone (NSA) and/or a standalone (SA).

The technical solutions according to the embodiments of the present disclosure may also applicable to machine-type communication (MTC), a long-term evolution-machine (LTE-M) technology, a device-to-device (D2D) network, a machine-to-machine (M2M) network, an IoT network, or other networks. The IoT network includes, for example, Internet of vehicles. Communication modes in the Internet of vehicles system are collectively referred to as vehicle-to-X (i.e., V2X, where X may represent any object). For example, the V2X may include: vehicle-to-vehicle (V2V) communication, vehicle-to-infrastructure (V2I) communication, vehicle-to-pedestrian (V2P) communication, vehicle-to-network (V2N) communication, or the like.

The mobile communication system according to the embodiments of the present disclosure is applicable to, but not limited to, at least one of: an uplink communication scenario, a downlink communication scenario, or an SL communication scenario.

FIG. 7 is a schematic flowchart of a positioning method according to some exemplary embodiments of the present disclosure. The method is illustrated by using an example where the method is performed by the terminal device as illustrated in FIG. 6. The method includes at least part of the following steps.

In step 710, first information is transmitted, wherein the first information is used to indicate an entry of a first terminal device into a first area or to request to activate and use first configuration information.

The first information is transmitted by the first terminal device to a network device, or the first information is transmitted by the first terminal device to another terminal device. The other terminal device refers to a terminal device other than the first terminal device.

In some embodiments, the other terminal device and the first terminal device are within the same network coverage; or the other terminal device and the first terminal device are within different network coverages; or neither the other terminal device nor the first terminal device is within network coverage; or one of the other terminal device and the first terminal device is not within network coverage.

The first information is transmitted upon the first terminal device entering the first area; or the first information is transmitted at a first time prior to the entry of the first terminal device into the first area; or the first information is transmitted at a second time following the entry of the first terminal device into the first area. The first time is the same as or different from the second time. The first time and the second time are configured by a network device, specified by a communication protocol, or determined by the first terminal device.

In the embodiments of the present disclosure, an area may be understood as a geographical area, a spatial area, or a network coverage. Each area has an identifier (ID), an index, or a serial number in one-to-one correspondence therewith, to allow the terminal device and the network device to distinguish between different areas.

In some embodiments, the division of areas is configured by a network device, determined via negotiation between the network device and the terminal device, or specified by a communication protocol.

Requesting to activate and use the first configuration information includes: requesting activation of transmission of an SL-PRS based on the first configuration information, and/or requesting activation of measurement on an SL-PRS based on the first configuration information.

In some embodiments, the first information is used by the first terminal device to request to use the first configuration information.

Requesting to use the first configuration information includes: requesting to transmit an SL-PRS based on the first configuration information, and/or requesting to perform measurement on an SL-PRS based on the first configuration information.

The first terminal device includes one or more terminal devices.

In step 730, an SL-PRS is transmitted based on the first configuration information, or an SL-PRS from a second terminal device is measured based on the first configuration information.

The first configuration information is associated with the first area. That is, the transmission of the SL-PRS by the first terminal device in the first area is performed based on the first configuration information. That is, the first configuration information includes configuration information of the SL-PRS transmitted in the first area.

The SL-PRS is transmitted and/or received between the first terminal device and the second terminal device over an SL.

The second terminal device belongs to the other terminal device, and the second terminal device is configured to assist in positioning the first terminal device.

In the present disclosure, the second terminal device is also referred to as an assisting positioning device, an assisting terminal device, or an anchor UE. The second terminal device includes one or more terminal devices.

Types of the first terminal device and the second terminal device are the same or different. For example, the first terminal device and the second terminal device are both vehicle-mounted devices, both smartphones, or the like. For another example, one of the first terminal device and the second terminal device is a vehicle-mounted device, and the other is a smartphone; or one of the first terminal device and the second terminal device is a smartphone, and the other is an RSU; or one of the first terminal device and the second terminal device is a vehicle-mounted device, and the other is an RSU; and so forth.

In some embodiments, the first terminal device transmits the SL-PRS via unicast based on the first configuration information; or the first terminal device transmits the SL-PRS via multicast based on the first configuration information; or the first terminal device transmits the SL-PRS via broadcast based on the first configuration information.

In summary, the method according to the embodiments of the present disclosure supports the first terminal device to notify the network device or other terminal devices of its entry into the first area or request to activate and use the first configuration information by transmitting the first information, enabling the network device or the other terminal devices to quickly and timely understand the positioning requirements of the first terminal device, thereby facilitating subsequent timely assistance from the network device or the other terminal devices in positioning the first terminal device and improving the positioning efficiency. In addition, the first configuration information based on which the SL-PRS is transmitted between the first terminal device and the second terminal device is associated with the first area, enabling the transmission of the SL-PRS using more targeted configuration information, thereby facilitating the improvement of the measurement accuracy of the SL-PRS and the accuracy of a positioning result.

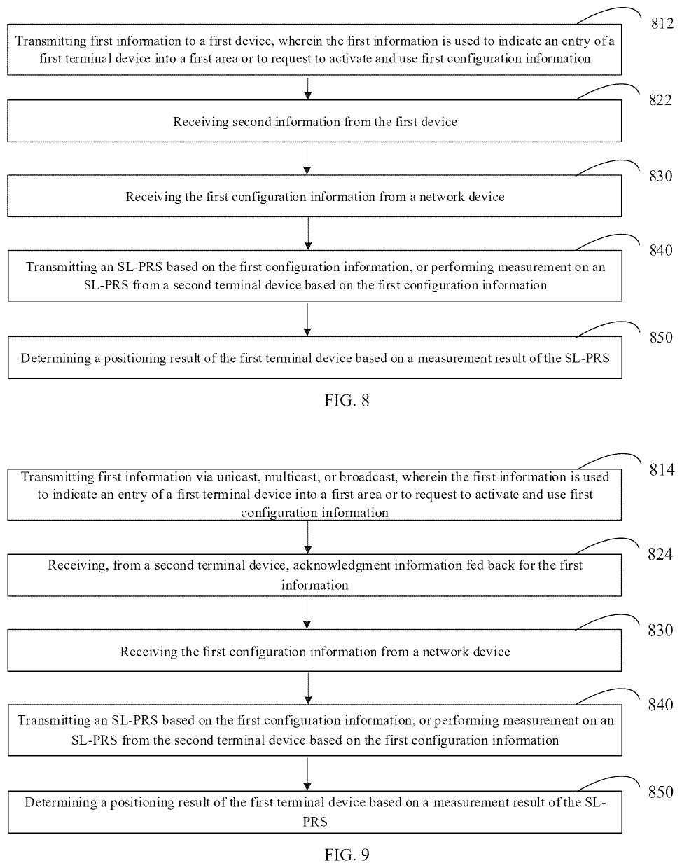

On the basis of the embodiments illustrated in FIG. 7, step 710 may be further implemented as step 812, and step 730 may be further implemented as step 840. The method may further include step 822, step 830, and step 850, as illustrated in FIG. 8.

FIG. 8 is a schematic flowchart of a positioning method according to some exemplary embodiments of the present disclosure. The method is illustrated by using an example where the method is performed by a first terminal device. The method includes at least part of the following steps.

In step 812, the first terminal device transmits first information to a first device, wherein the first information is used to indicate an entry of the first terminal device into a first area or to request to activate and use first configuration information.

The first device includes a network device and/or a third terminal device. Types of the third terminal device and the first terminal device are the same or different, and types of the third terminal device and a second terminal device are the same or different.

Exemplarily, the network device includes a CN device (e.g., an LMF) and/or an AN device.

Exemplarily, the third terminal device is a location server UE or an RSU.

In some embodiments, the area is represented by at least one of:
a radio access network (RAN)-based notification area (RNA);
a tracking area (TA);
a synchronization signal and PBCH block (SSB); or
a cell.

The PBCH is an abbreviation for a physical broadcast channel. In some embodiments, the cell represents a serving cell and/or a camping cell. In some embodiments, the cell includes a PCell and/or an SCell.

In some embodiments, the first information is transmitted by using radio resource control (RRC) signaling or a medium access control (MAC) control element (CE).

Exemplarily, the first information is transmitted by using RRC signaling, and the RRC signaling includes identification information of the first area. Exemplarily, the first information is transmitted by using an MAC CE, and the MAC CE includes index information of the first area.

In some embodiments, the first information is transmitted upon the first terminal device entering the first area from a second area. The second area is associated with second configuration information. For related content of the second configuration information, reference may be made to related content of the first configuration information hereinafter.

In some embodiments, the first information is transmitted at a first time prior to the entry of the first terminal device from the second area into the first area. Such a design allows the first device to be appropriately informed in advance of the positioning requirements of the first terminal device, thereby improving the efficiency and accelerating the procedure for subsequently assisting in positioning the first terminal device. In some embodiments, the first information includes information used to indicate the first time, to facilitate the first device in assisting in positioning the first terminal device more accurately.

In some embodiments, the first information is transmitted at a second time following the entry of the first terminal device from the second area into the first area. In a scenario where the first terminal device moves at a high speed and a large quantity of areas are close to the first terminal device, such a design allows the first device to assist in positioning the first terminal device more accurately, avoiding initiation of transmission, reception, or measurement of an SL-PRS by second terminal devices in irrelevant areas, thereby saving resources.

For other content, reference may be made to step 710, which is not repeated herein.

In step 822, the first terminal device receives second information from the first device.

In some embodiments, the second information is instruction information. The second information is used to instruct the first terminal device to transmit an SL-PRS, or used to instruct the first terminal device to perform measurement on an SL-PRS from the second terminal device.

In some embodiments, the second information is acknowledgment information fed back for the first information.

In step 830, the first terminal device receives the first configuration information from the network device.

The first configuration information is associated with the first area. Alternatively, the first configuration information is associated with a time window corresponding to the first area.

The first configuration information includes a first SL-PRS configuration associated with the first area.

In some embodiments, the configuration information received by the first terminal device from the network device includes at least two SL-PRS configurations, and the at least two SL-PRS configurations are associated with different areas, wherein an SL-PRS configuration associated with the first area of the at least two SL-PRS configurations belongs to the first configuration information.

In some embodiments, the configuration information received by the first terminal device from the network device includes: an SL-PRS group including at least two SL-PRSs; and/or an assistance message including at least two SL-PRSs; and/or a second terminal device ID associated with the SL-PRS; and/or geographical location information of the second terminal device associated with the SL-PRS. In some embodiments, the at least two SL-PRSs are associated with different second terminal devices.

In some embodiments, the configuration information received by the first terminal device from the network device is referred to the first configuration information.

In some embodiments, the first SL-PRS configuration includes at least one of:
an SL-PRS radio configuration;
an SL-PRS system frame number (SFN)-level offset;
an NR-absolute radio frequency channel number (NR-ARFCN);
an SL-PRS resource set ID;
an SL-PRS resource ID;
an SL-PRS periodicity-and-resource set slot offset;
an SL-PRS resource repetition factor;
an SL-PRS resource time gap;
an SL-PRS symbol number (or called SL-PRS NumSymbols);
an SL-PRS muting option 1;
an SL-PRS muting option 2; or
an SL-PRS resource list.

In some embodiments, the SL-PRS radio configuration includes at least one of:
a subcarrier spacing (SCS);
a resource bandwidth;
a start physical resource block (PRB);
a start position of a start frequency reference point (e.g., point A);
a comb size; or
a cyclic prefix.

The cyclic prefix may be normal or extended.

Exemplarily, fields for the above configurations are illustrated hereinafter by using examples.
A field ‘nr-SL-PRS-ResourceSetID’ indicates the SL-PRS resource set ID, which is used to identify the SL-PRS resource set ID of a TRP across all frequency layers.
A field ‘sl-PRS-Periodicity-and-ResourceSetSlotOffset’ indicates a periodicity of SL-PRS allocation in slots configured per SL-PRS resource set, and a slot offset with respect to SFN #0 slot #0 for a TRP where an SL-PRS resource set is configured (i.e., a slot where a first SL-PRS resource of the SL-PRS resource set occurs).
A field ‘sl-PRS-ResourceRepetitionFactor’ indicates the number of times each SL-PPS resource is repeated for a single instance of an SL-PRS resource set. This field is applied to all resources of the SL-PRS resource set. Enumerated values n2, n4, n6, n8, n16, and n32 correspond to 2, 4, 6, 8, 16, and 32 resource repetitions, respectively. In a case where the field is absent, a value for ‘sl-PRS ResourceRepetitionFactor’ is 1 (i.e., no resource repetition is present).
A field ‘sl-PRS-ResourceTimeGap’ indicates an offset in units of slots between two repeated instances of an SL-PRS resource, wherein the two repeated instances correspond to the same SL-PRS resource ID within a single instance of an SL-PRS resource set. A time duration spanned by an SL-PRS resource set containing repeated SL-PRS resources should not exceed an SL-PRS periodicity.
A field ‘sl-PRS-NumSymbols’ indicates the number of symbols occupied by each SL-PRS resource within a slot.
A field ‘sl-PRS-MutingOption1’ indicates an SL-PRS muting configuration of a TRP for muting option 1 (Option-1 muting), and includes at least one of the following subfields:
   A subfield ‘sl-prs-MutingBitRepetitionFactor’ indicates the number of consecutive instances of an SL-PRS resource set corresponding to a single bit of an nr-option1-muting bitmap. Enumerated values n1, n2, n4, and n8 correspond to 1, 2, 4, and 8 consecutive instances, respectively. In a case where the subfield is absent, a value for ‘sl-prs-MutingBitRepetitionFactor’ is n1.
   A subfield ‘nr-option1-muting’ defines a bitmap of time locations where an SL-PRS resource is transmitted (value “1”) or not transmitted (value “0”) for an SL-PRS resource set.

In a case where this subfield is absent, Optiona-1 muting is not in use for the TRP.
A field ‘sl-PRS-MutingOption2’ indicates an SL-PRS muting configuration of a TRP for muting option 2 (Option-2 muting), and may include the following subfields:
   A subfield ‘nr-option2-muting’ defines a bitmap of time locations where an SL-PRS resource is transmitted (value “1”) or not transmitted (value “0”). Each bit of the bitmap corresponds to a single repetition of the SL-PRS resource within an instance of an SL-PRS resource set. A size of the bitmap should be the same as a value for the SL-PRS resource repetition factor.

In a case where this subfield is absent, Option-2 muting is not in use for the TRP.
A field ‘sl-PRS-ResourcePower’ indicates an average energy per resource element (EPRE, where RE is the smallest unit in a resource grid) of REs that carry a PRS for PRS transmission, in the unit of dBm (decibel relative to one milliwatt). The UE assumes a constant EPRE for all REs of a given SL-PRS resource.
A field ‘sl-PRS-SequenceID’ indicates a sequence ID used to initialize a pseudo-random generator.
A field ‘sl-PRS-CombSizeN-AndReOffset’ indicates RE spacing in each symbol of an SL-PRS resource and an RE offset in a frequency domain for the first symbol in the SL-PRS resource. All SL-PRS resource sets belonging to the same positioning frequency layer have the same value of comb size. RE offsets of following symbols are defined relative to the RE offset in the frequency domain of the first symbol in the SL-PRS resource. The comb size configuration should be aligned with the comb size configuration for the frequency layer.
A field ‘sl-PRS-ResourceSlotOffset’ indicates a start slot of an SL-PRS resource with respect to a corresponding SL-PRS resource set slot offset.
A field ‘sl-PRS-ResourceSymbolOffset’ indicates a start symbol of an SL-PRS resource within a slot determined by an SL-PRS resource slot offset.
A field ‘sl-PRS-quasi-colocation information (QCL-Info)’ indicates a QCL indication with other SL RSs for serving and neighbor cells, and includes at least one of the following subfields:
1. A subfield ‘ssb’ indicates SSB information for a QCL source, and includes at least one of the following subfields:
   A subfield ‘physical cell identifier (pci)’ indicates a physical cell ID of a cell with an SSB that is configured as a source RS for an SL-PRS. A UE obtains an SSB configuration for the SSB configured as the source RS for the SL-PRS by indexing to a field “nr-SSB-Config” with the physical cell identifier.
   A subfield ‘ssb-Index’ indicates an index for an SSB configured as a source RS for an SL-PRS.
   A subfield ‘rs-Type’ indicates a QCL type.
2. A subfield ‘sl-PRS’ indicates PRS information for a QCL source RS, and includes at least one of the following subfields:
   A subfield ‘qcl-SL-PRS-ResourceID’ indicates an SL-PRS resource ID of an SL-PRS resource used as the source RS.
   A subfield ‘qcl-SL-PRS-ResourceSetID’ indicates an SL-PRS resource set ID of an SL-PRS resource set used as the source RS.
A field ‘sl-PRS-ResourcePrioritySubset’ provides a subset of SL-PRS resources, wherein the subset is associated with ‘nr-SL-PRS resource ID’ for the purpose of prioritization of SL-angle-of-departure (AoD) reporting. This field is only applicable to an SL-AoD positioning method and should be ignored for SL-time difference of arrival (TDoA) and multi-round trip time (RTT) positioning.

Exemplarily, the network device configures the first SL-PRS configuration for the first terminal device by using at least one of the above fields.

In some embodiments, prior to performing step 830, the first terminal device further transmits, to the network device, an SL-PRS configuration expected by the first terminal device, an SL-PRS configuration required by the first terminal device, or an SL-PRS configuration supported by the first terminal device. In some embodiments, the network device configures the first SL-PRS configuration for the first terminal device based on the received SL-PRS configuration that is expected, required, or supported by the first terminal device.

In step 840, the first terminal device transmits an SL-PRS based on the first configuration information, or performs measurement on an SL-PRS from the second terminal device based on the first configuration information.

For related content, reference may be made to step 730, which is not repeated herein.

In step 850, a positioning result of the first terminal device is determined based on a measurement result of the SL-PRS.

The measurement result of the SL-PRS is determined by the first terminal device; or the measurement result of the SL-PRS is determined by the second terminal device.

In some embodiments, the first terminal device transmits the SL-PRS to the second terminal device based on the first configuration information, and then the SL-PRS is measured by the second terminal device. In some embodiments, the second terminal device transmits the measurement result of the SL-PRS to the first terminal device, and the first terminal device determines the positioning result of the first terminal device based on the measurement result of the SL-PRS. In some embodiments, the second terminal device determines the positioning result of the first terminal device based on the measurement result of the SL-PRS, and the second terminal device transmits the positioning result of the first terminal device to the first terminal device.

In some embodiments, the first terminal device performs measurement on the SL-PRS from the second terminal device based on the first configuration information. In some embodiments, the first terminal device determines the positioning result of the first terminal device based on the measurement result of the SL-PRS.

In some embodiments, the first terminal device notifies the network device or other terminal devices of its positioning result.

It should be understood that, in the embodiments of the present disclosure, step 822, step 830, and step 850 are optional. The execution order of the above steps may be adjusted according to actual circumstances. For example, step 830 is performed before step 812, step 830 is performed before step 822, or the like. The above steps may be combined or split according to actual circumstances. For example, step 812 and step 822 may be combined into a single step, step 840 and step 850 may be combined into a single step, or the like.

In summary, the method according to the embodiments of the present disclosure supports the first terminal device to notify the network device or the third terminal device of its entry into the first area or to request to activate and use the first configuration information by transmitting the first information, enabling the network device or the third terminal device to quickly and timely understand the positioning requirements of the first terminal device, thereby facilitating subsequent timely assistance from the network device or the third terminal device in positioning the first terminal device and improving the positioning efficiency. In addition, the first configuration information based on which the SL-PRS is transmitted between the first terminal device and the second terminal device is associated with the first area, enabling the transmission of the SL-PRS using more targeted configuration information, thereby facilitating the improvement of the measurement accuracy of the SL-PRS and the accuracy of a positioning result.

On the basis of the embodiments illustrated in FIG. 7, step 710 may be further implemented as step 814, and step 730 may be further implemented as step 840. The method may further include step 824, step 830, and step 850, as illustrated in FIG. 9.

FIG. 9 is a schematic flowchart of a positioning method according to some exemplary embodiments of the present disclosure. The method is illustrated by using an example where the method is performed by a first terminal device. The method includes at least part of the following steps.

In step 814, the first terminal device transmits first information via unicast, multicast, or broadcast, wherein the first information is used to indicate an entry of the first terminal device into a first area or to request to activate and use first configuration information.

In some embodiments, the first information includes identification information, index information, or serial number information of the first area.

For other content, reference may be made to step 710 and step 812, which are not repeated herein.

In step 824, the first terminal device receives, from a second terminal device, acknowledgment information fed back for the first information.

The acknowledgment information is used to indicate that the second terminal device acknowledges receipt of the first information, or used to indicate that the second terminal device acknowledges its intention to transmit an SL-PRS to the first terminal device, or used to indicate that the second terminal device acknowledges its readiness to receive an SL-PRS from the first terminal device.

In some embodiments, the first terminal device transmits the first information via multicast, and the second terminal device feeds back the acknowledgment information for the first information.

In some embodiments, the first terminal device transmits the first information via broadcast, and the second terminal device feeds back or does not feed back the acknowledgment information for the first information.

In step 830, the first terminal device receives the first configuration information from a network device.

For related content, reference may be made to the foregoing descriptions, which are not repeated herein.

In step 840, the first terminal device transmits an SL-PRS based on the first configuration information, or performs measurement on an SL-PRS from the second terminal device based on the first configuration information.

For related content, reference may be made to step 730, which is not repeated herein.

In step 850, a positioning result of the first terminal device is determined based on a measurement result of the SL-PRS.

The measurement result of the SL-PRS is determined by the first terminal device; or the measurement result of the SL-PRS is determined by the second terminal device.

In some embodiments, the first terminal device transmits the SL-PRS to the second terminal device based on the first configuration information, and then the SL-PRS is measured by the second terminal device. In some embodiments, the second terminal device transmits the measurement result of the SL-PRS to the first terminal device, and the first terminal device determines the positioning result of the first terminal device based on the measurement result of the SL-PRS. In some embodiments, the second terminal device determines the positioning result of the first terminal device based on the measurement result of the SL-PRS, and the second terminal device transmits the positioning result of the first terminal device to the first terminal device.

In some embodiments, the first terminal device performs measurement on the SL-PRS from the second terminal device based on the first configuration information. In some embodiments, the first terminal device determines the positioning result of the first terminal device based on the measurement result of the SL-PRS.

In some embodiments, the first terminal device notifies the network device or other terminal devices of its positioning result.

It should be understood that, in the embodiments of the present disclosure, step 824, step 830, and step 850 are optional. The execution order of the above steps may be adjusted according to actual circumstances. For example, step 830 is performed before step 814, step 830 is performed before step 824, or the like. The above steps may be combined or split according to actual circumstances. For example, step 814 and step 824 may be combined into a single step, step 840 and step 850 may be combined into a single step, or the like.

In summary, the method according to the embodiments of the present disclosure supports the first terminal device to notify the second terminal device of its entry into the first area or to request to activate and use the first configuration information by transmitting the first information, enabling the second terminal device to quickly and timely understand the positioning requirements of the first terminal device, thereby facilitating subsequent timely assistance from the second terminal device in positioning the first terminal device and improving the positioning efficiency. In addition, the first configuration information based on which the SL-PRS is transmitted between the first terminal device and the second terminal device is associated with the first area, enabling the transmission of the SL-PRS using more targeted configuration information, thereby facilitating the improvement of the measurement accuracy of the SL-PRS and the accuracy of a positioning result. Moreover, a network device or a third terminal device is not required to transfer the first information, and the first information is directly exchanged between the first terminal device and the second terminal device, such that an overall procedure of the positioning method is faster and simpler, reducing the resource consumption.

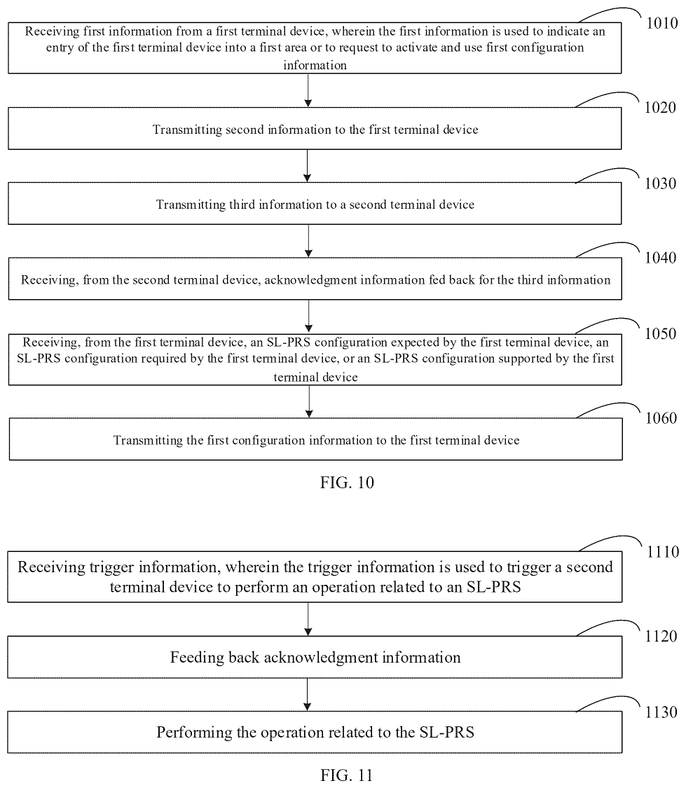

FIG. 10 is a schematic flowchart of a positioning method according to some exemplary embodiments of the present disclosure. The method is illustrated by using an example where the method is performed by the network device as illustrated in FIG. 1. The method includes at least part of the following steps.

In step 1010, the network device receives first information from a first terminal device, wherein the first information is used to indicate an entry of the first terminal device into a first area or to request to activate and use first configuration information.

The first information is transmitted upon the first terminal device entering the first area; or the first information is transmitted at a first time prior to the entry of the first terminal device into the first area; or the first information is transmitted at a second time following the entry of the first terminal device into the first area. The first time is the same as or different from the second time. The first time and the second time are configured by the network device, specified by a communication protocol, or determined by the first terminal device.

In the embodiments of the present disclosure, an area may be understood as a geographical area, a spatial area, or a network coverage. Each area has an ID, an index, or a serial number in one-to-one correspondence therewith, to allow the terminal device and the network device to distinguish between different areas.

In some embodiments, the division of areas is configured by the network device, determined via negotiation between the network device and the terminal device, or specified by a communication protocol.

Exemplarily, the network device includes a CN device (e.g., an LMF) and/or an AN device.

In some embodiments, the area is represented by at least one of: an RNA; a TA; an SSB; or a cell.

In some embodiments, the cell represents a serving cell and/or a camping cell. In some embodiments, the cell includes a PCell and/or an SCell.

Requesting to activate and use the first configuration information includes: requesting activation of transmission of an SL-PRS based on the first configuration information, and/or requesting activation of measurement on the SL-PRS based on the first configuration information.

In some embodiments, the first information is transmitted by using RRC signaling or an MAC CE.

Exemplarily, the first information is transmitted by using RRC signaling, and the RRC signaling includes identification information of the first area. Exemplarily, the first information is transmitted by using an MAC CE, and the MAC CE includes index information of the first area.

In some embodiments, the first information is transmitted upon the first terminal device entering the first area from a second area. The second area is associated with second configuration information. For related content of the second configuration information, reference may be made to related content of the first configuration information.

In some embodiments, the first information is transmitted at the first time prior to the entry of the first terminal device from the second area into the first area. Such a design allows the network device to be appropriately informed in advance of the positioning requirements of the first terminal device, thereby improving the efficiency and accelerating the procedure for subsequently assisting in positioning the first terminal device. In some embodiments, the first information includes information used to indicate the first time, to facilitate the network device in assisting in positioning the first terminal device more accurately.

In some embodiments, the first information is transmitted at the second time following the entry of the first terminal device from the second area into the first area. In a scenario where the first terminal device moves at a high speed and a large quantity of areas are close to the first terminal device, such a design allows the network device to assist in positioning the first terminal device more accurately, avoiding initiation of transmission, reception, or measurement of the SL-PRS by second terminal devices in irrelevant areas, thereby saving resources.

In step 1020, the network device transmits second information to the first terminal device.

In some embodiments, the second information is instruction information. The second information is used to instruct the first terminal device to transmit an SL-PRS, or used to instruct the first terminal device to perform measurement on an SL-PRS from the second terminal device.

In some embodiments, the second information is acknowledgment information fed back for the first information.

In some embodiments, the second information is transmitted by using RRC signaling or an MAC CE.

In step 1030, the network device transmits third information to a second terminal device.

The third information is used to instruct the second terminal device to perform at least one of: initiating transmission of an SL-PRS; initiating reception of an SL-PRS; or performing measurement on an SL-PRS.

In some embodiments, the third information is used to instruct the second terminal device to initiate transmission of the SL-PRS. Alternatively, the third information is used to instruct the second terminal device to initiate reception of the SL-PRS. Alternatively, the third information is used to instruct the second terminal device to perform measurement on the SL-PRS. Alternatively, the third information is used to instruct the second terminal device to initiate reception of the SL-PRS and perform measurement on the received SL-PRS.

The third information may be understood as trigger information used to trigger the second terminal device to assist in positioning the first terminal device. The second terminal device does not initiate reception, measurement, or transmission of the SL-PRS until it receives the trigger information, which facilitates reducing the power consumption of the second terminal device and avoiding unnecessary resource consumption in a scenario where the reception, measurement, or transmission of the SL-PRS is not required for the second terminal device.

In step 1040, the network device receives, from the second terminal device, acknowledgment information fed back for the third information.

The acknowledgment information is used to indicate that the second terminal device acknowledges receipt of the third information, or used to indicate that the second terminal device acknowledges its intention to transmit the SL-PRS to the first terminal device, or used to indicate that the second terminal device acknowledges its readiness to receive an SL-PRS from the first terminal device.

In some embodiments, the network device transmits the third information via unicast, multicast, or broadcast, and the second terminal device feeds back or does not feed back the acknowledgment information for the third information.

In step 1050, the network device receives, from the first terminal device, an SL-PRS configuration expected by the first terminal device, an SL-PRS configuration required by the first terminal device, or an SL-PRS configuration supported by the first terminal device.

In step 1060, the network device transmits the first configuration information to the first terminal device.

The first configuration information is associated with the first area. Alternatively, the first configuration information is associated with a time window corresponding to the first area.

The first configuration information includes a first SL-PRS configuration associated with the first area.

In some embodiments, the configuration information transmitted by the network device to the first terminal device includes at least two SL-PRS configurations, and the at least two SL-PRS configurations are associated with different areas, wherein an SL-PRS configuration associated with the first area in the at least two SL-PRS configurations belongs to the first configuration information.

In some embodiments, the configuration information transmitted by the network device to the first terminal device includes: an SL-PRS group including at least two SL-PRSs; and/or an assistance message including at least two SL-PRSs; and/or a second terminal device ID associated with the SL-PRS; and/or geographical location information of the second terminal device associated with the SL-PRS. In some embodiments, the at least two SL-PRSs are associated with different second terminal devices.

In some embodiments, the configuration information transmitted by the network device to the first terminal device is referred to the first configuration information.

For related content of the first SL-PRS configuration, reference may be made to step 830, which is not repeated herein.

In some embodiments, the network device configures the first SL-PRS configuration for the first terminal device based on the received SL-PRS configuration that is expected, required, or supported by the first terminal device.

In some embodiments, in addition to transmitting the first configuration information to the first terminal device, the network device further transmits the first configuration information to the second terminal device.

It should be understood that, in the embodiments of the present disclosure, step 1020, step 1030, step 1040, step 1050, and step 1060 are optional. The execution order of the above steps may be adjusted according to actual circumstances. For example, step 1050 is performed before step 1010, step 1050 is performed before step 1020, step 1050 is performed before step 1030, step 1050 is performed before step 1040, step 1060 is performed before step 1010, step 1060 is performed before step 1020, step 1060 is performed before step 1030, step 1060 is performed before step 1040, or the like. The above steps may be combined or split according to actual circumstances. For example, step 1020 and step 1030 may be combined into a single step, step 1010 and step 1050 may be combined into a single step, step 1020 and step 1060 may be combined into a single step, or the like.

In summary, the method according to the embodiments of the present disclosure supports the network device to quickly and timely understand the positioning requirements of the first terminal device by receiving the first information, facilitating subsequent timely assistance from the network device in positioning the first terminal device and improving the positioning efficiency. In addition, the network device is supported to transmit the third information to the second terminal device upon receiving the first information, to timely trigger the second terminal device to assist in positioning the first terminal device, ensuring the positioning efficiency. In a scenario where direct communication is unavailable between the first terminal device and the second terminal device, or where the first terminal device and the second terminal device are unaware of the presence of each other, the information relay function of the network device further ensures the positioning efficiency. In addition, the first configuration information configured by the network device for the first terminal device is associated with the first area, such that the more targeted configuration information is used to transmit the SL-PRS between the first terminal device and the second terminal device, thereby facilitating the improvement of the measurement accuracy of the SL-PRS and the accuracy of the positioning result.

In a case where the first device includes a third terminal device, the execution steps of the third terminal device are similar to those of the network device. For example, the third terminal device performs at least one of step 1010, step 1020, step 1030, or step 1040. In the present disclosure, the functionality of the third terminal device is similar to that of the network device. Both the third terminal device and the network device may be configured to receive and transmit the first information, the second information, the third information, and the acknowledgment information fed back for the third information, and support transmission of the trigger information via an information relay mode in a scenario where direct communication is unavailable between the first terminal device and the second terminal device, or where the first terminal device and the second terminal device are unaware of the presence of each other, enabling the second terminal device to assist in positioning the first terminal device timely, quickly, and accurately.

FIG. 11 is a schematic flowchart of a positioning method according to some exemplary embodiments of the present disclosure. The method is illustrated by using an example where the method is performed by a second terminal device. The method includes at least part of the following steps.

In step 1110, the second terminal device receives trigger information, wherein the trigger information is used to trigger the second terminal device to perform an operation related to an SL-PRS.

The operation related to the SL-PRS includes at least one of: initiating transmission of the SL-PRS; initiating reception of the SL-PRS; or performing measurement on the SL-PRS.

In some embodiments, the trigger information is used to trigger the second terminal device to initiate transmission of the SL-PRS. Alternatively, the trigger information is used to trigger the second terminal device to initiate reception of the SL-PRS. Alternatively, the trigger information is used to trigger the second terminal device to perform measurement on the SL-PRS. Alternatively, the trigger information is used to trigger the second terminal device to initiate reception of the SL-PRS and perform measurement on the received SL-PRS.

In some embodiments, the trigger information includes first information, wherein the first information is used to indicate an entry of a first terminal device into a first area or to request to activate and use first configuration information. In some embodiments, the first information is transmitted by the first terminal device. Accordingly, step 1110 is further implemented as step 1110a.

In step 1110a, the second terminal device receives the first information from the first terminal device.

In some embodiments, the trigger information includes third information. The third information is used to instruct the second terminal device to perform at least one of: initiating transmission of the SL-PRS; initiating reception of the SL-PRS; or performing measurement on the SL-PRS.

In some embodiments, the third information is used to instruct the second terminal device to initiate transmission of the SL-PRS. Alternatively, the third information is used to instruct the second terminal device to initiate reception of the SL-PRS. Alternatively, the third information is used to instruct the second terminal device to perform measurement on the SL-PRS. Alternatively, the third information is used to instruct the second terminal device to initiate reception of the SL-PRS and perform measurement on the received SL-PRS.

In some embodiments, the third information is transmitted by a first device, and the first device includes at least one of a network device or a third terminal device. Therefore, step 1110 is further implemented as step 1110b.

In step 1110b, the second terminal device receives the third information from the first device.

Types of the third terminal device and the first terminal device are the same or different, and types of the third terminal device and the second terminal device are the same or different.

Exemplarily, the network device includes a CN device (e.g., an LMF) and/or an AN device.

Exemplarily, the third terminal device is a location server UE or an RSU.

In some embodiments, the second terminal device and the first terminal device are within the same network coverage; or the second terminal device and the first terminal device are within different network coverages; or neither the second terminal device nor the first terminal device is within network coverage; or one of the second terminal device and the first terminal device is not within network coverage.

In some embodiments, types of the first terminal device and the second terminal device are the same or different.

In some embodiments, the second terminal device is also referred to as an assisting positioning device, an assisting terminal device, or an anchor UE. The second terminal device includes one or more terminal devices.

In some embodiments, the trigger information is transmitted via unicast, multicast, or broadcast.

In some embodiments, prior to receiving the trigger information, the second terminal device is in a sleep state, a low-power state, or an energy-saving state. Upon receiving the trigger information, the second terminal device enters an awake state or a normal operating state.

In some embodiments, prior to receiving the trigger information, the second terminal device does not transmit the SL-PRS, does not receive the SL-PRS, or does not perform measurement on the received SL-PRS. Upon receiving the trigger information, the second terminal device performs an operation related to the SL-PRS, such as at least one of: initiating transmission of the SL-PRS; initiating reception of the SL-PRS; or performing measurement on the SL-PRS.

In some embodiments, prior to receiving the trigger information, the second terminal device does not transmit the SL-PRS to the first terminal device or does not receive the SL-PRS from the first terminal device. Upon receiving the trigger information, the second terminal device transmits the SL-PRS to the first terminal device or receives the SL-PRS from the first terminal device.

In step 1120, the second terminal device feeds back acknowledgment information.

The acknowledgment information is used to indicate that the second terminal device acknowledges receipt of the trigger information, or used to indicate that the second terminal device acknowledges its intention to transmit the SL-PRS to the first terminal device, or used to indicate that the second terminal device acknowledges its readiness to receive an SL-PRS from the first terminal device.

In some embodiments, the trigger information includes the first information, and the second terminal device transmits acknowledgment information fed back for the first information. Exemplarily, the second terminal device transmits the acknowledgment information fed back for the first information to the first terminal device.

In some embodiments, the trigger information includes the third information, and the second terminal device transmits acknowledgment information fed back for the third information. Exemplarily, the second terminal device transmits the acknowledgment information fed back for the first information to the first device.

In step 1130, the second terminal device performs the operation related to the SL-PRS.

The operation related to the SL-PRS includes at least one of: initiating transmission of the SL-PRS; initiating reception of the SL-PRS; or performing measurement on the SL-PRS.

In some embodiments, step 1130 is implemented as: initiating, by the second terminal device, transmission of the SL-PRS. Alternatively, step 1130 is implemented as: initiating, by the second terminal device, reception of the SL-PRS. Alternatively, step 1130 is implemented as: performing, by the second terminal device, measurement on the SL-PRS. Alternatively, step 1130 is implemented as: initiating reception of the SL-PRS and performing measurement on the received SL-PRS by the second terminal device.

The SL-PRS is transmitted based on the first configuration information. For related content of the first configuration information, reference may be made to step 830, which is not repeated herein.

The first configuration information is associated with the first area. That is, the transmission of the SL-PRS by the first terminal device in the first area is performed based on the first configuration information. That is, the first configuration information includes configuration information of the SL-PRS transmitted in the first area.

The SL-PRS is transmitted and/or received between the first terminal device and the second terminal device over an SL.

A measurement result of the SL-PRS is determined by the first terminal device; or the measurement result of the SL-PRS is determined by the second terminal device.

In some embodiments, the first terminal device transmits the SL-PRS to the second terminal device based on the first configuration information, and then the SL-PRS is measured by the second terminal device. In some embodiments, the second terminal device transmits the measurement result of the SL-PRS to the first terminal device, and the first terminal device determines a positioning result of the first terminal device based on the measurement result of the SL-PRS. In some embodiments, the second terminal device determines the positioning result of the first terminal device based on the measurement result of the SL-PRS, and the second terminal device transmits the positioning result of the first terminal device to the first terminal device.

In some embodiments, the first terminal device performs measurement on the SL-PRS from the second terminal device based on the first configuration information. In some embodiments, the first terminal device determines the positioning result of the first terminal device based on the measurement result of the SL-PRS.

In some embodiments, the first terminal device notifies the network device or other terminal devices of its positioning result.

In some embodiments, upon completion of the measurement on the SL-PRS, the second terminal device reverts to the state it was in prior to performing step 1110. Alternatively, upon transmission of the positioning result to the first terminal device, the second terminal device reverts to the state it was in prior to performing step 1110. Alternatively, upon transmission of the measurement result of the SL-PRS to the first terminal device, the second terminal device reverts to the state it was prior to performing step 1110. Alternatively, upon transmission of the SL-PRS to the first terminal device, the second terminal device reverts to the state it was prior to performing step 1110.

Reverting to the state prior to performing step 1110 includes at least one of: reverting to the sleep state; reverting to the low-power state; reverting to the energy-saving state; stopping transmission of the SL-PRS; stopping reception of the SL-PRS; stopping performing measurement on the SL-PRS; stopping transmission of the SL-PRS to the first terminal device; or stopping reception of the SL-PRS from the first terminal device.

It should be understood that, in the embodiments of the present disclosure, step 1120 and step 1130 are optional. The execution order of the above steps may be adjusted according to actual circumstances. For example, step 1130 is performed before step 1120, or the like. The above steps may be combined or split according to actual circumstances. For example, step 1120 and step 1130 may be combined into a single step, step 1110 and step 1120 may be combined into a single step, or the like.

In summary, the method according to the embodiments of the present disclosure supports the second terminal device to quickly and timely understand the positioning requirements of the first terminal device by receiving the trigger information, facilitating subsequent timely assistance from the second terminal device in positioning the first terminal device and improving the positioning efficiency. In addition, the second terminal device is supported to feed back the acknowledgment information to the first terminal device upon receiving the first information, to notify the first terminal device about the situation where the second terminal device initiates reception or transmission of the SL-PRS, thereby improving the system efficiency. In a case where the second terminal device, upon receiving the first information, directly initiates reception or transmission of the SL-PRS without feeding back the acknowledgment information, this facilitates reducing signaling resource consumption. In a scenario where direct communication is unavailable between the first terminal device and the second terminal device, or where the first terminal device and the second terminal device are unaware of the presence of each other, the design of relay of the trigger information by the first device further ensures the positioning efficiency and accuracy. In addition, the first configuration information is associated with the first area, such that the more targeted configuration information is used to transmit the SL-PRS between the first terminal device and the second terminal device, thereby improving the measurement accuracy of the SL-PRS and the accuracy of the positioning result.

With respect to the second terminal device, it does not initiate reception of the SL-PRS or transmission of the SL-PRS or measurement on the SL-PRS until the second terminal device receives the trigger information. The second terminal device initiates one or more operations related to the SL-PRS, such as reception of the SL-PRS, transmission of the SL-PRS, or measurement on the SL-PRS in a case where the trigger information has been received. This facilitates reducing the power consumption of the second terminal device and avoiding unnecessary resource consumption in a scenario where the reception, measurement, or transmission of the SL-PRS is not required for the second terminal device.

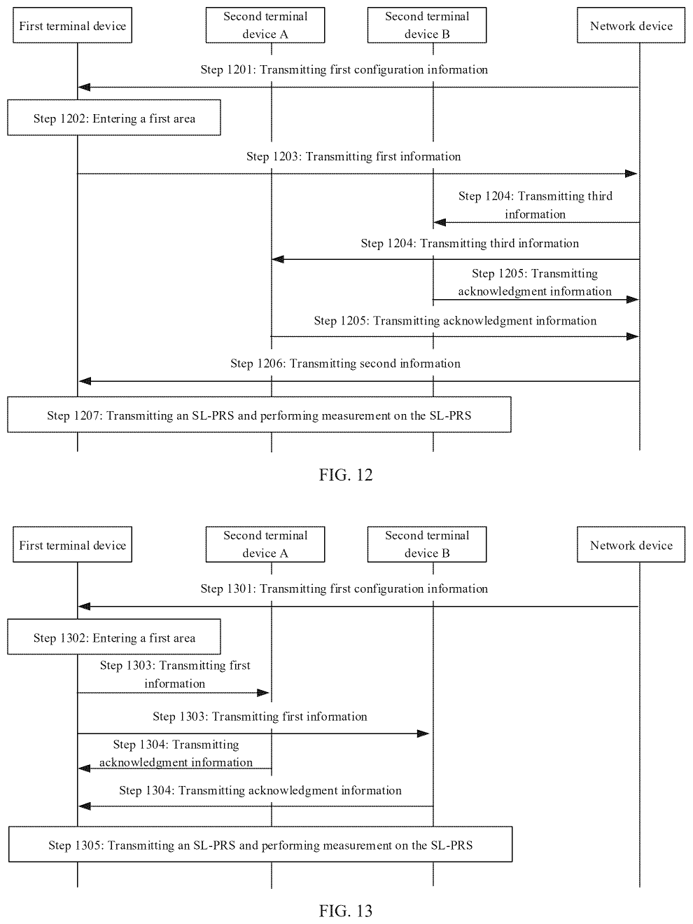

FIG. 12 is a schematic flowchart of a positioning method according to some exemplary embodiments of the present disclosure. The method is illustrated by using an example where the method is performed by a first terminal device, a network device, and a second terminal device. The method includes at least part of the following steps.

In step 1201, the network device transmits first configuration information to the first terminal device.

The first configuration information is associated with a first area. Alternatively, the first configuration information is associated with a time window corresponding to the first area.

The first configuration information includes a first SL-PRS configuration associated with the first area.

In some embodiments, the configuration information transmitted by the network device to the first terminal device includes at least two SL-PRS configurations, and the at least two SL-PRS configurations are associated with different areas, wherein an SL-PRS configuration associated with the first area of the at least two SL-PRS configurations belongs to the first configuration information.

In some embodiments, the configuration information transmitted by the network device to the first terminal device includes: an SL-PRS group including at least two SL-PRSs; and/or an assistance message including at least two SL-PRSs; and/or a second terminal device ID associated with the SL-PRS; and/or geographical location information of the second terminal device associated with the SL-PRS. In some embodiments, the at least two SL-PRSs are associated with different second terminal devices.

In some embodiments, the configuration information transmitted by the network device to the first terminal device is referred to the first configuration information.

For related content of the first SL-PRS configuration, reference may be made to step 830, which is not repeated herein.

In some embodiments, the network device configures the first SL-PRS configuration for the first terminal device based on a received SL-PRS configuration that is expected by the first terminal device, required by the first terminal device, or supported by the first terminal device.

In some embodiments, before step 1201 is performed, the first terminal device transmits, to the network device, the SL-PRS configuration expected by the first terminal device, the SL-PRS configuration required by the first terminal device, or the SL-PRS configuration supported by the first terminal device. In some embodiments, the network device configures the first SL-PRS configuration for the first terminal device based on the received SL-PRS configuration that is expected, required, or supported by the first terminal device.

In some embodiments, in addition to transmitting the first configuration information to the first terminal device, the network device further transmits the first configuration information to the second terminal device.

Exemplarily, the first configuration information is pre-configured assistance data, or the first configuration information includes the pre-configured assistance data.

In step 1202, the first terminal device enters the first area (e.g., the first terminal device enters area 1).

The first terminal device moves to the first area from another area, for example, moves to the first area from a second area. The second area is associated with second configuration information. For related content of the second configuration information, reference may be made to related content of the first configuration information.

In step 1203, the first terminal device transmits first information to the network device.

The first information is used to indicate an entry of the first terminal device into the first area or to request to activate and use the first configuration information.

The first information is transmitted upon the first terminal device entering the first area; or the first information is transmitted at a first time prior to the entry of the first terminal device into the first area; or the first information is transmitted at a second time following the entry of the first terminal device into the first area. The first time is the same as or different from the second time. The first time and the second time are configured by the network device, specified by a communication protocol, or determined by the first terminal device.

Each area has an ID, an index, or a serial number in one-to-one correspondence therewith, to allow the terminal device and the network device to distinguish between different areas.

In some embodiments, the division of areas is configured by the network device, determined via negotiation between the network device and the terminal device, or specified by a communication protocol.

Exemplarily, the network device includes a CN device (e.g., an LMF) and/or an AN device.

In some embodiments, the area is represented by at least one of: an RNA; a TA; an SSB; or a cell.

In some embodiments, the cell represents a serving cell and/or a camping cell. In some embodiments, the cell includes a PCell and/or an SCell.

In some embodiments, the first information is transmitted by using RRC signaling or an MAC CE.

Exemplarily, the first information is transmitted by using RRC signaling, and the RRC signaling includes identification information of the first area. Exemplarily, the first information is transmitted by using an MAC CE, and the MAC CE includes index information of the first area.

In some embodiments, the first information is transmitted upon the first terminal device entering the first area from the second area. The second area is associated with the second configuration information. For related content of the second configuration information, reference may be made to related content of the first configuration information.

Exemplarily, the first information is prompt information for entering a new area, and the prompt information includes an area ID of the first area (e.g., the first information is notification of entering new area with area ID #1).

In step 1204, the network device transmits third information to the second terminal device.

The third information is used to instruct the second terminal device to perform at least one of: initiating transmission of the SL-PRS; initiating reception of the SL-PRS; or performing measurement on the received SL-PRS.

In some embodiments, the third information is used to instruct the second terminal device to initiate transmission of the SL-PRS. Alternatively, the third information is used to instruct the second terminal device to initiate reception of the SL-PRS. Alternatively, the third information is used to instruct the second terminal device to perform measurement on the received SL-PRS. Alternatively, the third information is used to instruct the second terminal device to initiate reception of the SL-PRS and perform measurement on the received SL-PRS.

The third information may be understood as trigger information used to trigger the second terminal device to assist in positioning the first terminal device. The second terminal device does not initiate reception, measurement, or transmission of the SL-PRS until it receives the trigger information, which facilitates reducing the power consumption of the second terminal device and avoiding unnecessary resource consumption in a scenario where the reception, measurement, or transmission of the SL-PRS is not required for the second terminal device.

Exemplarily, the second terminal device includes a second terminal device A and a second terminal device B. The second terminal device is located in the first area.

Exemplarily, the third information is the trigger information, and is used to trigger reception and/or measurement of the SL-PRS from the first terminal device, or used to trigger transmission of the SL-PRS to the first terminal device. The trigger information includes a device ID of the first terminal device (e.g., the third information is used to trigger monitoring/transmission of SL-PRS from/towards target UE1 with UE1 ID).

In step 1205, the second terminal device transmits acknowledgment information to the network device.

The acknowledgment information is used to indicate that the second terminal device acknowledges receipt of the third information, or used to indicate that the second terminal device acknowledges its intention to transmit the SL-PRS to the first terminal device, or used to indicate that the second terminal device acknowledges its readiness to receive the SL-PRS from the first terminal device.

In some embodiments, the network device transmits the third information via unicast, multicast, or broadcast, and the second terminal device feeds back or does not feed back the acknowledgment information for the third information.

Exemplarily, the acknowledgment information is an ACK message, wherein ACK represents acknowledge/acknowledgment.

In step 1206, the network device transmits second information to the first terminal device.

In some embodiments, the second information is instruction information. The second information is used to instruct the first terminal device to transmit the SL-PRS, or used to instruct the first terminal device to perform measurement on the SL-PRS from the second terminal device.

In some embodiments, the second information is acknowledgment information fed back for the first information.

In some embodiments, the second information is transmitted by using RRC signaling or an MAC CE.

Exemplarily, the first information is a Request message, and the second information is an ACK message (Acknowledge of Request) for the first information.

In step 1207, the SL-PRS is transmitted and measured between the first terminal device and the second terminal device.

The SL-PRS is transmitted based on the first configuration information. For related content of the first configuration information, reference may be made to step 830, which is not repeated herein.

The SL-PRS is transmitted and/or received between the first terminal device and the second terminal device over an SL.

A measurement result of the SL-PRS is determined by the first terminal device; or the measurement result of the SL-PRS is determined by the second terminal device.

In some embodiments, the first terminal device transmits the SL-PRS to the second terminal device based on the first configuration information, and then the SL-PRS is measured by the second terminal device. In some embodiments, the second terminal device transmits the measurement result of the SL-PRS to the first terminal device, and the first terminal device determines a positioning result of the first terminal device based on the measurement result of the SL-PRS. In some embodiments, the second terminal device determines the positioning result of the first terminal device based on the measurement result of the SL-PRS, and the second terminal device transmits the positioning result of the first terminal device to the first terminal device.

In some embodiments, the first terminal device performs measurement on the SL-PRS from the second terminal device based on the first configuration information. In some embodiments, the first terminal device determines the positioning result of the first terminal device based on the measurement result of the SL-PRS.

In some embodiments, the first terminal device notifies the network device or other terminal devices of its positioning result.

It should be understood that, in the embodiments of the present disclosure, step 1205 and step 1206 are optional. The execution order of the above steps may be adjusted according to actual circumstances. For example, step 1203 is performed before step 1202, step 1202 is performed before step 1201, step 1203 is performed before step 1201, or the like. The above steps may be combined or split according to actual circumstances. For example, step 1202 and step 1203 may be combined into a single step, step 1201 and step 1204 may be combined into a single step, step 1207 may be split into two steps (an SL-PRS transmission step and an SL-PRS measurement step), or the like.

In summary, the method according to the embodiments of the present disclosure supports the network device to quickly and timely understand the positioning requirements of the first terminal device via transmission of the first information, facilitating subsequent timely assistance from the second terminal device in positioning the first terminal device and improving the positioning efficiency. In addition, the network device is supported to transmit the third information to the second terminal device upon receiving the first information, to timely trigger the second terminal device to assist in positioning the first terminal device, ensuring the positioning efficiency. In a scenario where direct communication is unavailable between the first terminal device and the second terminal device, or where the first terminal device and the second terminal device are unaware of the presence of each other, the information relay function of the network device further ensures the positioning efficiency. In addition, the first configuration information configured by the network device for the first terminal device is associated with the first area, such that the more targeted configuration information is used to transmit the SL-PRS between the first terminal device and the second terminal device, thereby facilitating the improvement of the measurement accuracy of the SL-PRS and the accuracy of the positioning result.

With respect to the second terminal device, it does not initiate reception and measurement of the SL-PRS, or transmission of the SL-PRS, or perform measurement on the SL-PRS until the second terminal device receives the third information from the network device. The second terminal device initiates one or more operations related to the SL-PRS, such as reception and measurement of the SL-PRS, transmission of the SL-PRS, or performing measurement on the SL-PRS in a case where the third information has been received. This facilitates reducing the power consumption of the second terminal device and avoiding unnecessary resource consumption in a scenario where the reception, measurement, or transmission of the SL-PRS is not required for the second terminal device.

FIG. 13 is a schematic flowchart of a positioning method according to some exemplary embodiments of the present disclosure. The method is illustrated by using an example where the method is performed by a first terminal device, a network device, and a second terminal device. The method includes at least part of the following steps.

In step 1301, the network device transmits first configuration information to the first terminal device.

The first configuration information is associated with a first area. Alternatively, the first configuration information is associated with a time window corresponding to the first area.

The first configuration information includes a first SL-PRS configuration associated with the first area.

In some embodiments, the configuration information transmitted by the network device to the first terminal device includes at least two SL-PRS configurations, and the at least two SL-PRS configurations are associated with different areas, wherein an SL-PRS configuration associated with the first area of the at least two SL-PRS configurations belongs to the first configuration information.

In some embodiments, the configuration information transmitted by the network device to the first terminal device includes: an SL-PRS group including at least two SL-PRSs; and/or an assistance message including at least two SL-PRSs; and/or a second terminal device ID associated with the SL-PRS; and/or geographical location information of the second terminal device associated with the SL-PRS. In some embodiments, the at least two SL-PRSs are associated with different second terminal devices.

In some embodiments, the configuration information transmitted by the network device to the first terminal device is referred to as the first configuration information.

For related content of the first SL-PRS configuration, reference may be made to step 830, which is not repeated herein.

In some embodiments, the network device configures the first SL-PRS configuration for the first terminal device based on a received SL-PRS configuration that is expected by the first terminal device, required by the first terminal device, or supported by the first terminal device.

In some embodiments, before step 1301 is performed, the first terminal device transmits, to the network device, the SL-PRS configuration expected by the first terminal device, the SL-PRS configuration required by the first terminal device, or the SL-PRS configuration supported by the first terminal device. In some embodiments, the network device configures the first SL-PRS configuration for the first terminal device based on the received SL-PRS configuration that is expected, required, or supported by the first terminal device.

In some embodiments, in addition to transmitting the first configuration information to the first terminal device, the network device further transmits the first configuration information to the second terminal device.

Exemplarily, the first configuration information is pre-configured assistance data, or the first configuration information includes the pre-configured assistance data.

In step 1302, the first terminal device enters the first area.

The first terminal device moves to the first area from another area, for example, moves to the first area from a second area. The second area is associated with second configuration information. For related content of the second configuration information, reference may be made to related content of the first configuration information.

In step 1303, the first terminal device transmits first information.

The first information is used to indicate an entry of the first terminal device into the first area or to request to activate and use the first configuration information.

The first terminal device transmits the first information via unicast, multicast, or broadcast.

The first information is transmitted upon the first terminal device entering the first area; or the first information is transmitted at a first time prior to the entry of the first terminal device into the first area; or the first information is transmitted at a second time following the entry of the first terminal device into the first area. The first time is the same as or different from the second time. The first time and the second time are configured by the network device, specified by a communication protocol, or determined by the first terminal device.

Each area has an ID, an index, or a serial number in one-to-one correspondence therewith, to allow the terminal device and the network device to distinguish between different areas.

In some embodiments, the division of areas is configured by the network device, determined via negotiation between the network device and the terminal device, or specified by a communication protocol.

Exemplarily, the network device includes a CN device (e.g., an LMF) and/or an AN device.

In some embodiments, the area is represented by at least one of: an RNA; a TA; an SSB; or a cell.

In some embodiments, the cell represents a serving cell and/or a camping cell. In some embodiments, the cell includes a PCell and/or an SCell.

In some embodiments, the second terminal device and the first terminal device are within the same network coverage; or the second terminal device and the first terminal device are within different network coverages; or neither the second terminal device nor the first terminal device is within network coverage; or one of the second terminal device and the first terminal device is not within network coverage.

In some embodiments, types of the first terminal device and the second terminal device are the same or different.

In some embodiments, the second terminal device is also referred to as an assisting positioning device, an assisting terminal device, or an anchor terminal device.

In some embodiments, the first information includes identification information, index information, or serial number information of the first area.

In some embodiments, the first terminal device transmits the first information to the second terminal device upon the first terminal device entering the first area from the second area. The second area is associated with the second configuration information. For related content of the second configuration information, reference may be made to related content of the first configuration information.

Exemplarily, the first information is prompt information for entering a new area, and the prompt information includes an area ID of the first area (e.g., the first information is notification of entering new area with area ID #1).

In step 1304, the second terminal device transmits acknowledgment information to the first terminal device.

The acknowledgment information is used to indicate that the second terminal device acknowledges the receipt of the first information, or used to indicate that the second terminal device acknowledges its intention to transmit the SL-PRS to the first terminal device, or used to indicate that the second terminal device acknowledges its readiness to receive the SL-PRS from the first terminal device.

In some embodiments, the first terminal device transmits the first information via multicast, and the second terminal device feeds back the acknowledgment information for the first information.

In some embodiments, the first terminal device transmits the first information via broadcast, and the second terminal device feeds back or does not feed back the acknowledgment information for the first information.

Exemplarily, the second terminal device includes a second terminal device A and a second terminal device B. The second terminal device is located in the first area.

Exemplarily, the first information is a Request message (e.g., the first information is used to request to activate and use the first configuration information), and the acknowledgment information transmitted by the second terminal device is an ACK message (e.g., Acknowledge of Request) for the first information.

In step 1305, the SL-PRS is transmitted and measured between the first terminal device and the second terminal device.

The SL-PRS is transmitted based on the first configuration information. For related content of the first configuration information, reference may be made to step 830, which is not repeated herein.

The SL-PRS is transmitted and/or received between the first terminal device and the second terminal device over an SL.

A measurement result of the SL-PRS is determined by the first terminal device; or the measurement result of the SL-PRS is determined by the second terminal device.

In some embodiments, the first terminal device transmits the SL-PRS to the second terminal device based on the first configuration information, and then the SL-PRS is measured by the second terminal device. In some embodiments, the second terminal device transmits the measurement result of the SL-PRS to the first terminal device, and the first terminal device determines a positioning result of the first terminal device based on the measurement result of the SL-PRS. In some embodiments, the second terminal device determines the positioning result of the first terminal device based on the measurement result of the SL-PRS, and the second terminal device transmits the positioning result of the first terminal device to the first terminal device.

In some embodiments, the first terminal device performs measurement on the SL-PRS from the second terminal device based on the first configuration information. In some embodiments, the first terminal device determines the positioning result of the first terminal device based on the measurement result of the SL-PRS.

In some embodiments, the first terminal device notifies the network device or other terminal devices of its positioning result.

It should be understood that, in the embodiments of the present disclosure, step 1304 is optional. That is, the second terminal device may directly receive and measure the SL-PRS from the first terminal device or directly transmit the SL-PRS to the first terminal device without feeding back the acknowledgment information. That is, the first terminal device may directly transmit the SL-PRS, or receive and measure the SL-PRS upon transmitting the first information. The execution order of the above steps may be adjusted according to actual circumstances. For example, step 1303 is performed before step 1302, step 1302 is performed before step 1301, step 1303 is performed before step 1301, or the like. The above steps may be combined or split according to actual circumstances. For example, step 1302 and step 1303 may be combined into a single step, step 1305 may be split into two steps (an SL-PRS transmission step and an SL-PRS measurement step), or the like.

In summary, the method according to the embodiments of the present disclosure supports the network device to quickly and timely understand the positioning requirements of the first terminal device via transmission of the first information, facilitating subsequent timely assistance from the second terminal device in positioning the first terminal device and improving the positioning efficiency. In addition, the network device is supported to transmit the third information to the second terminal device upon receiving the first information, to timely trigger the second terminal device to assist in positioning the first terminal device, ensuring the positioning efficiency. In a scenario where direct communication is unavailable between the first terminal device and the second terminal device, or where the first terminal device and the second terminal device are unaware of the presence of each other, the information relay function of the network device further ensures the positioning efficiency. In addition, the first configuration information configured by the network device for the first terminal device is associated with the first area, such that the more targeted configuration information is used to transmit the SL-PRS between the first terminal device and the second terminal device, facilitating improving the measurement accuracy of the SL-PRS and the accuracy of the positioning result.

With respect to the second terminal device, it does not initiate reception and measurement of the SL-PRS, or transmission of the SL-PRS, or perform measurement on the SL-PRS until the second terminal device receives the third information from the network device. The second terminal device initiates one or more operations related to the SL-PRS, such as reception of the SL-PRS, transmission of the SL-PRS, or measurement on the SL-PRS in a case where the third information has been received. This facilitates reducing the power consumption of the second terminal device and avoiding unnecessary resource consumption in a scenario where the reception, measurement, or transmission of the SL-PRS is not required for the second terminal device.

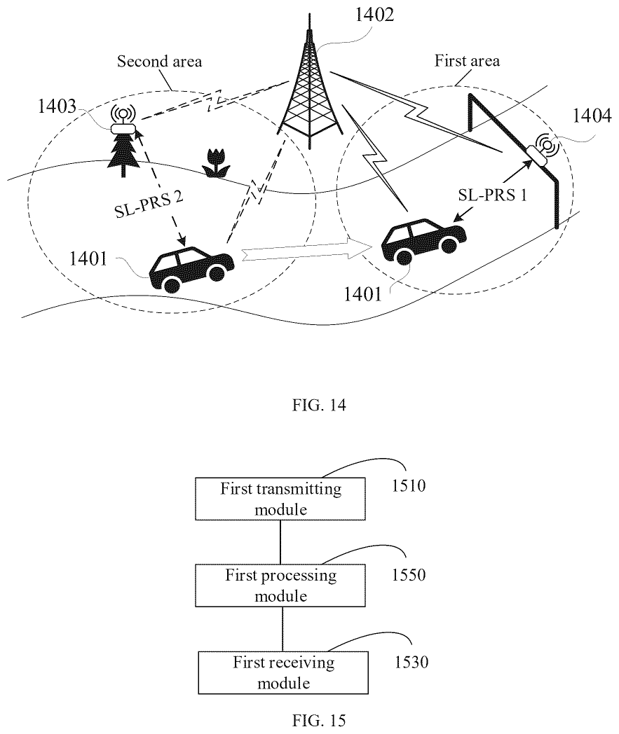

FIG. 14 is a schematic diagram of a positioning method according to some exemplary embodiments of the present disclosure. The method is illustrated by using an example where the method is performed by a first terminal device, a network device, and a second terminal device.

A first terminal device 1401 enters a first area from a second area. The second area has an overlapping portion or does not have an overlapping portion with the first area. FIG. 14 is illustrated by using an example where no overlapping portion is present between the second area and the first area.

A second terminal device 1403 is located within the second area. A second terminal device 1404 is located within the first area. A network device 1402 may communicate with the first terminal device 1401 and/or the second terminal device 1403 and/or the second terminal device 1404. The second terminal device 1403 includes one or more terminal devices. The second terminal device 1404 includes one or more terminal devices.

Exemplarily, the network device 1402 transmits second configuration information to the first terminal device 1401, wherein the second configuration information includes a second SL-PRS configuration, and the second SL-PRS configuration is, for example, a configuration of an SL-PRS 2. For specific information included in the second SL-PRS configuration, reference may be made to related content of the first SL-PRS configuration in step 830.

Exemplarily, the network device 1402 transmits first configuration information to the first terminal device 1401, wherein the first configuration information includes a first SL-PRS configuration, and the first SL-PRS configuration is, for example, a configuration of an SL-PRS 1.

Exemplarily, the configuration information transmitted by the network device 1402 to the first terminal device 1401 includes configurations of at least two SL-PRSs, and the configurations of the at least two SL-PRSs include, for example, the second SL-PRS configuration and the first SL-PRS configuration. In some embodiments, the configurations of the at least two SL-PRSs further include a third SL-PRS configuration.

The second SL-PRS configuration is associated with the second area, the first SL-PRS configuration is associated with the first area, and the third SL-PRS configuration is associated with a third area (not shown). The third area is an area other than the first area and the second area. The third area has an overlapping portion or does not have an overlapping portion with the first area or the second area.

Similarly, the network device 1402 may also transmit the first configuration information to the second terminal device 1404 and transmit the second configuration information to the second terminal device 1403, such that the different second terminal devices transmit SL-PRSs to the first terminal device 1401 by using SL-PRS configurations corresponding to the areas where the different second terminal devices are located.

In a case where the first terminal device 1401 is in the second area, the SL-PRS 2 may be transmitted between the first terminal device 1401 and the second terminal device 1403, to determine a positioning result of the first terminal device 1401. In this case, since the first terminal device 1401 has not yet entered the first area, the second terminal device 1404 within the first area does not transmit the SL-PRS or does not receive and measure the SL-PRS. Furthermore, the second terminal device 1404 may be in a sleep state or an energy-saving state, to reduce power consumption of the second terminal device 1404.

Exemplarily, the first terminal device 1401 transmits the SL-PRS 2 to the second terminal device 1403 by using the second SL-PRS configuration, and the second terminal device 1403 performs measurement on the SL-PRS 2. The second terminal device 1403 feeds back a measurement result of the SL-PRS 2 to the first terminal device 1401, or feeds back the positioning result of the first terminal device 1401 obtained based on the measurement result of the SL-PRS 2.

In a case where the first terminal device 1401 has entered the first area, the SL-PRS 1 may be transmitted between the first terminal device 1401 and the second terminal device 1404, to determine a positioning result of the first terminal device 1401. In this case, since the first terminal device 1401 has entered the first area, positioning is no longer implemented by the second terminal device 1403 in the second area. The second terminal device 1403 may stop transmission of the SL-PRS, or stop reception and measurement of the SL-PRS. Furthermore, the second terminal device 1403 may enter a sleep state or an energy-saving state, to reduce power consumption of the second terminal device 1403.

Exemplarily, the first terminal device 1401 transmits first information to the network device 1402, to notify the network device 1402 of its entry into the first area. Upon receiving the first information, the network device 1402 transmits third information to the second terminal device 1404, to instruct the second terminal device 1404 to initiate reception and measurement of the SL-PRS or initiate transmission of the SL-PRS.

Exemplarily, the first terminal device 1401 transmits the first information to the second terminal device 1404, to notify the second terminal device 1404 of its entry into the first area. Upon receiving the first information, the second terminal device 1404 initiates reception and measurement of the SL-PRS, or initiates transmission of the SL-PRS.

Following the transmission of the first information, the first terminal device 1401 directly transmits the SL-PRS 1 to the second terminal device 1404 by using the first SL-PRS configuration. Alternatively, following the transmission of the first information, the first terminal device 1401 directly receives the SL-RPS 1 and performs measurement on the SL-PRS 1. Alternatively, the first terminal device 1401 shall not transmit the SL-PRS 1 to the second terminal device 1404 by using the first SL-PRS configuration until the first terminal device 1401 receives acknowledgment information for the first information. Alternatively, the first terminal device 1401 shall not receive the SL-PRS 1 and perform measurement on the SL-PRS 1 until the first terminal device 1401 receives acknowledgment information for the first information. With transmission of the first information, the network device 1402 and/or the second terminal device 1404 are enabled to be informed of the cross-area action of the first terminal device 1401 timely, such that the second terminal device 1404 is capable of receiving the SL-PRS and performing measurement on the SL-PRS or transmitting the SL-PRS timely, thereby ensuring the positioning efficiency.

In a case where the second terminal device 1404 transmits the SL-PRS 1 to the first terminal device 1401, the transmission of the SL-PRS 1 is performed based on the first SL-PRS configuration. The first terminal device 1401 transmits the SL-PRS or performs measurement on the SL-PRS in different areas by using SL-PRS configurations corresponding to the areas, such that the measurement results of the SL-PRS are more in line with actual situations of the areas, thereby effectively improving the accuracy of the positioning results of the first terminal device 1401.

FIG. 15 is a schematic structural diagram of a positioning apparatus according to some exemplary embodiments of the present disclosure. The apparatus includes at least part of a first transmitting module 1510, a first receiving module 1530, or a first processing module 1550.

The first transmitting module 1510 is configured to transmit first information, wherein the first information is used to indicate an entry of the apparatus into a first area or to request to activate and use first configuration information.

The first transmitting module 1510 is further configured to transmit an SL-PRS based on the first configuration information; or the first processing module 1550 is configured to perform measurement on an SL-PRS from a second terminal device based on the first configuration information.

The first configuration information is associated with the first area.

In some embodiments, the first transmitting module 1510 is further configured to transmit the first information to a first device, wherein the first device includes at least one of a network device or a third terminal device.

In some embodiments, the apparatus further includes the first receiving module 1530 configured to receive second information from the first device, wherein the second information is used to instruct the apparatus to transmit the SL-PRS, or used to instruct the apparatus to perform measurement on the SL-PRS from the second terminal device.

In some embodiments, the first transmitting module 1510 is further configured to transmit the first information via unicast, multicast, or broadcast.

In some embodiments, the first receiving module 1530 is further configured to receive, from the second terminal device, acknowledgment information fed back for the first information.

In some embodiments, the apparatus further includes the first processing module 1550 configured to determine a positioning result of the apparatus based on a measurement result of the SL-PRS.

In some embodiments, the measurement result of the SL-PRS is determined by the apparatus; or the measurement result of the SL-PRS is determined by the second terminal device.

In some embodiments, the first receiving module 1530 is further configured to receive, from a network device, the first configuration information, wherein the first configuration information includes a first SL-PRS configuration associated with the first area.

In some embodiments, the first SL-PRS configuration includes at least one of: an SL-PRS radio configuration; an SL-PRS SFN-level offset; an NR-ARFCN; an SL-PRS resource set ID; an SL-PRS resource ID; an SL-PRS periodicity-and-resource set slot offset; an SL-PRS resource repetition factor; an SL-PRS resource time gap; an SL-PRS symbol number; an SL-PRS muting option 1; an SL-PRS muting option 2; an SL-PRS resource list; an SL-PRS group including at least two SL-PRSs; or a second terminal device ID associated with the SL-PRS.

In some embodiments, the SL-PRS radio configuration includes at least one of: an SCS; a resource bandwidth; a start PRB; a start position of a start frequency reference point; a comb size; or a cyclic prefix.

In some embodiments, the first transmitting module 1510 is further configured to transmit, to the network device, an SL-PRS configuration expected by the apparatus, an SL-PRS configuration required by the apparatus, or an SL-PRS configuration supported by the apparatus.

In some embodiments, the first transmitting module 1510 is further configured to transmit the first information in response to the apparatus entering the first area from a second area; wherein the second area is associated with second configuration information.

In some embodiments, the first area is represented by at least one of: an RNA; a TA; an SSB; or a cell.

In some embodiments, the first configuration information is associated with a time window corresponding to the first area.

In some embodiments, the apparatus according to the embodiments of the present disclosure includes one first transmitting module 1510. The first transmitting module 1510 supports performing all the transmission steps performed by the terminal device in the above embodiments.

In some embodiments, the apparatus according to the embodiments of the present disclosure includes a plurality of first transmitting modules 1510. The plurality of first transmitting modules 1510 respectively support performing part of the transmission steps performed by the terminal device in the above embodiments.

In some embodiments, the steps performed by different first transmitting modules 1510 are completely the same, partially the same, or completely different.

In some embodiments, the apparatus according to the embodiments of the present disclosure includes one first processing module 1550. The first processing module 1550 supports performing all the steps related to processing, all the steps related to determination, and all the steps related to measurement, which are performed by the terminal device in the above embodiments.

In some embodiments, the apparatus according to the embodiments of the present disclosure includes a plurality of first processing modules 1550. The plurality of first processing modules 1550 respectively support performing part of the steps related to processing, part of the steps related to determination, and part of the steps related to measurement, which are performed by the terminal device in the above embodiments.

In some embodiments, the steps performed by different first processing modules 1550 are completely the same, partially the same, or completely different.

In some embodiments, the apparatus according to the embodiments of the present disclosure includes one first receiving module 1530. The first receiving module 1530 supports performing all the reception steps performed by the terminal device in the above embodiments.

In some embodiments, the apparatus according to the embodiments of the present disclosure includes a plurality of first receiving modules 1530. The plurality of first receiving modules 1530 respectively support performing part of the reception steps performed by the terminal device in the above embodiments.

In some embodiments, the steps performed by different first receiving modules 1530 are completely the same, partially the same, or completely different.

In summary, the apparatus according to the embodiments of the present disclosure supports notifying the network device or other terminal devices of its entry into the first area or requesting to activate and use the first configuration information by transmitting the first information, to enable the network device or the other terminal devices to quickly and timely understand the positioning requirements of the apparatus, facilitating subsequent timely assistance from the network device or the other terminal devices in positioning the apparatus and improving the positioning efficiency. In addition, the first configuration information based on which the SL-PRS is transmitted between the apparatus and the second terminal device is associated with the first area, enabling the transmission of the SL-PRS using more targeted configuration information, thereby facilitating the improvement of the measurement accuracy of the SL-PRS and the accuracy of a positioning result.

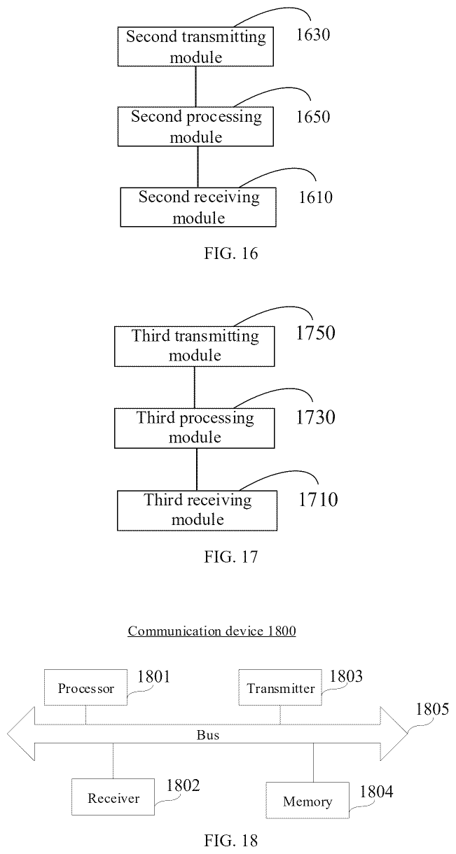

FIG. 16 is a schematic structural diagram of a positioning apparatus according to some exemplary embodiments of the present disclosure. The apparatus includes at least part of a second receiving module 1610, a second transmitting module 1630, or a second processing module 1650.

The second receiving module 1610 is configured to receive first information from a first terminal device, wherein the first information is used to indicate an entry of the first terminal device into a first area or to request to activate and use first configuration information, wherein the first area is associated with the first configuration information.

In some embodiments, the apparatus further includes the second transmitting module 1630 configured to transmit second information to the first terminal device, wherein the second information is used to instruct the first terminal device to transmit an SL-PRS, or used to instruct the first terminal device to perform measurement on an SL-PRS from a second terminal device.

In some embodiments, the second transmitting module 1630 is further configured to transmit third information to a second terminal device, wherein the third information is used to instruct the second terminal device to perform at least one of: initiating transmission of an SL-PRS, initiating reception of an SL-PRS, or initiating measurement on an SL-PRS.

In some embodiments, the second receiving module 1610 is further configured to receive, from the second terminal device, acknowledgment information fed back for the third information.

In some embodiments, the second transmitting module 1630 is further configured to transmit the first configuration information to the first terminal device, wherein the first configuration information includes a first SL-PRS configuration associated with the first area.

In some embodiments, the first SL-PRS configuration includes at least one of: an SL-PRS radio configuration; an SL-PRS SFN-level offset; an NR-ARFCN; an SL-PRS resource set ID; an SL-PRS resource ID; an SL-PRS periodicity-and-resource set slot offset; an SL-PRS resource repetition factor; an SL-PRS resource time gap; an SL-PRS symbol number; an SL-PRS muting option 1; an SL-PRS muting option 2; an SL-PRS resource list; an SL-PRS group including at least two SL-PRSs; or a second terminal device ID associated with the SL-PRS.

In some embodiments, the SL-PRS radio configuration includes at least one of: an SCS; a resource bandwidth; a start PRB; a start position of a start frequency reference point; a comb size; or a cyclic prefix.

In some embodiments, the second receiving module 1610 is further configured to receive, from the first terminal device, an SL-PRS configuration expected by the first terminal device, an SL-PRS configuration required by the first terminal device, or an SL-PRS configuration supported by the first terminal device.

In some embodiments, the first area is represented by at least one of: an RNA; a TA; an SSB; or a cell.

In some embodiments, the first configuration information is associated with a time window corresponding to the first area.

In some embodiments, the apparatus further includes the second processing module 1650 configured to determine or generate the first configuration information.

In some embodiments, the second processing module 1650 is configured to determine the first configuration information based on the SL-PRS configuration expected by the first terminal device, the SL-PRS configuration required by the first terminal device, or the SL-PRS configuration supported by the first terminal device, as received from the first terminal device.

In some embodiments, the apparatus according to the embodiments of the present disclosure includes one second receiving module 1610. The second receiving module 1610 supports performing all the reception steps performed by the network device in the above embodiments.

In some embodiments, the apparatus according to the embodiments of the present disclosure includes a plurality of second receiving modules 1610. The plurality of second receiving modules 1610 respectively support performing part of the reception steps performed by the network device in the above embodiments.

In some embodiments, the steps performed by different second receiving modules 1610 are completely the same, partially the same, or completely different.

In some embodiments, the apparatus according to the embodiments of the present disclosure includes one second processing module 1650. The second processing module 1650 supports performing all the steps related to processing, all the steps related to determination, and all the steps related to measurement, which are performed by the network device in the above embodiments.

In some embodiments, the apparatus according to the embodiments of the present disclosure includes a plurality of second processing modules 1650. The plurality of second processing modules 1650 respectively support performing part of the steps related to processing, part of the steps related to determination, and part of the steps related to measurement, which are performed by the network device in the above embodiments.

In some embodiments, the steps performed by different second processing modules 1650 are completely the same, partially the same, or completely different.

In some embodiments, the apparatus according to the embodiments of the present disclosure includes one second transmitting module 1630. The second transmitting module 1630 supports performing all the transmission steps performed by the network device in the above embodiments.

In some embodiments, the apparatus according to the embodiments of the present disclosure includes a plurality of second transmitting modules 1630. The plurality of second transmitting modules 1630 respectively support performing part of the transmission steps performed by the network device in the above embodiments.

In some embodiments, the steps performed by different second transmitting modules 1630 are completely the same, partially the same, or completely different.

In summary, the apparatus according to the embodiments of the present disclosure quickly and timely understands the positioning requirements of the first terminal device by receiving the first information, facilitating subsequent timely assistance from the apparatus in positioning the first terminal device and improving the positioning efficiency. In addition, the apparatus is supported to transmit the third information to the second terminal device upon receiving the first information, to timely trigger the second terminal device to assist in positioning the first terminal device, ensuring the positioning efficiency. In a scenario where direct communication is unavailable between the first terminal device and the second terminal device, or where the first terminal device and the second terminal device are unaware of the presence of each other, the information relay function of the apparatus further ensures the positioning efficiency. In addition, the first configuration information configured by the apparatus for the first terminal device is associated with the first area, such that the more targeted configuration information is used to transmit the SL-PRS between the first terminal device and the second terminal device, thereby facilitating the improvement of the measurement accuracy of the SL-PRS and the accuracy of the positioning result.

FIG. 17 is a schematic structural diagram of a positioning apparatus according to some exemplary embodiments of the present disclosure. The apparatus includes at least part of a third receiving module 1710, a third processing module 1730, or a third transmitting module 1750.

The third receiving module 1710 is configured to receive trigger information, wherein the trigger information is used to trigger the apparatus to perform at least one of: initiating transmission of an SL-PRS, initiating reception of an SL-PRS, or initiating measurement on an SL-PRS, wherein the SL-PRS is transmitted based on first configuration information.

In some embodiments, the trigger information includes first information, and the first information is used to indicate an entry of a first terminal device into a first area or to request to activate and use the first configuration information.

In some embodiments, the third receiving module 1710 is further configured to receive the first information from the first terminal device.

In some embodiments, the apparatus further includes the third processing module 1730 configured to perform at least one of: initiating transmission of the SL-PRS, initiating reception of the SL-PRS, or initiating measurement on the SL-PRS.

In some embodiments, the apparatus further includes the third transmitting module 1750 configured to transmit, to the first terminal device, acknowledgment information fed back for the first information.

In some embodiments, the trigger information includes third information, and the third information is used to instruct the apparatus to perform at least one of: initiating transmission of the SL-PRS, initiating reception of the SL-PRS, or initiating measurement on the SL-PRS.

In some embodiments, the third receiving module 1710 is further configured to receive the third information from a first device, wherein the first device includes at least one of a network device or a third terminal device, and the third information is transmitted based on first information, wherein the first information is used to indicate an entry of a first terminal device into a first area or to request to activate and use the first configuration information.

In some embodiments, the third transmitting module 1750 is configured to transmit, to the first device, acknowledgment information fed back for the third information.

In some embodiments, the first area is represented by at least one of: an RNA; a TA; an SSB; or a cell.

In some embodiments, the first area is associated with the first configuration information, or a time window corresponding to the first area is associated with the first configuration information.

In some embodiments, the apparatus according to the embodiments of the present disclosure includes one third transmitting module 1750. The third transmitting module 1750 supports performing all the transmission steps performed by the terminal device in the above embodiments.

In some embodiments, the apparatus according to the embodiments of the present disclosure includes a plurality of third transmitting modules 1750. The plurality of third transmitting modules 1750 respectively support performing part of the transmission steps performed by the terminal device in the above embodiments.

In some embodiments, the steps performed by different third transmitting modules 1750 are completely the same, partially the same, or completely different.

In some embodiments, the apparatus according to the embodiments of the present disclosure includes one third processing module 1730. The third processing module 1730 supports performing all the steps related to processing, all the steps related to determination, and all the steps related to measurement, which are performed by the terminal device in the above embodiments.

In some embodiments, the apparatus according to the embodiments of the present disclosure includes a plurality of third processing modules 1730. The plurality of third processing modules 1730 respectively support performing part of the steps related to processing, part of the steps related to determination, and part of the steps related to measurement, which are performed by the terminal device in the above embodiments.

In some embodiments, the steps performed by different third processing modules 1730 are completely the same, partially the same, or completely different.

In some embodiments, the apparatus according to the embodiments of the present disclosure includes one third receiving module 1710. The third receiving module 1710 supports performing all the reception steps performed by the terminal device in the above embodiments.

In some embodiments, the apparatus according to the embodiments of the present disclosure includes a plurality of third receiving modules 1710. The plurality of third receiving modules 1710 respectively support performing part of the reception steps performed by the terminal device in the above embodiments.

In some embodiments, the steps performed by different third receiving modules 1710 are completely the same, partially the same, or completely different.

In summary, the apparatus according to the embodiments of the present disclosure supports the apparatus to quickly and timely understand the positioning requirements of the first terminal device by receiving the trigger information, facilitating subsequent timely assistance from the apparatus in positioning the first terminal device and improving the positioning efficiency. In addition, the apparatus is supported to feed back the acknowledgment information to the first terminal device upon receiving the first information, to notify the first terminal device about the situation where the apparatus initiates reception, measurement, or transmission of the SL-PRS, thereby improving the system efficiency. In a case where the apparatus, upon receiving the first information, directly initiates reception, measurement, or transmission of the SL-PRS without feeding back the acknowledgment information, this facilitates reducing signaling resource consumption. In a scenario where direct communication is unavailable between the first terminal device and the apparatus, or where the first terminal device and the apparatus are unaware of the presence of each other, the design of relay of the trigger information by the first device further ensures the positioning efficiency and accuracy. In addition, the first configuration information is associated with the first area, such that the more targeted configuration information is used to transmit the SL-PRS between the first terminal device and the apparatus, thereby improving the measurement accuracy of the SL-PRS and the accuracy of the positioning result.

With respect to the apparatus, it does not initiate reception, measurement, or transmission of the SL-PRS until the apparatus receives the trigger information. The apparatus initiates reception, measurement, or transmission of the SL-PRS in a case where the trigger information has been received. This facilitates reducing the power consumption of the apparatus and avoiding unnecessary resource consumption in a scenario where the reception, measurement, or transmission of the SL-PRS is not required for the apparatus.

It should be noted that, for the apparatus according to the above embodiments, the division of the functional modules is merely exemplary. In practical applications, the functions described above may be assigned to different functional modules as needed, that is, the internal structure of the device may be divided into different functional modules, to implement all or part of the above functions.

With regard to the apparatus in the embodiments, the specific manner in which each module performs operations is described in detail in the embodiments related to the method, which is not elaborated herein.

FIG. 18 is a schematic structural diagram of a communication device (a terminal device or a network device) according to some exemplary embodiments of the present disclosure. The communication device 1800 includes: a processor 1801, a receiver 1802, a transmitter 1803, a memory 1804, and a bus 1805.

The processor 1801 includes one or more processing cores, and the processor 1801 executes various functional applications and performs information processing by running software programs and modules. In some embodiments, the processor 1801 is configured to implement the functions and steps of the first processing module 1550 and/or the second processing module 1650 and/or the third processing module 1730 as described above.

The receiver 1802 and the transmitter 1803 may be implemented as a communication assembly, which may be a communication chip. In some embodiments, the receiver 1802 is configured to implement the functions and steps of the first receiving module 1530 and/or the second receiving module 1610 and/or the third receiving module 1710 as described above. In some embodiments, the transmitter 1803 is configured to implement the functions and steps of the first transmitting module 1510 and/or the second transmitting module 1630 and/or the third transmitting module 1750 as described above.

The memory 1804 is communicably connected to the processor 1801 via the bus 1805. The memory 1804 is configured to store at least one instruction, and the processor 1801 is configured to execute the at least one instruction to perform the steps in the above method embodiments.

In addition, the memory 1804 may be implemented by any type of a volatile or non-volatile storage device or a combination thereof. The volatile or non-volatile storage device includes, but not limited to: a magnetic or optical disk, an electrically-erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

In some embodiments, the receiver 1802 independently receives signals/data, or the processor 1801 controls the receiver 1802 to receive signals/data, or the processor 1801 requests the receiver 1802 to receive signals/data, or the processor 1801 cooperates with the receiver 1802 to receive signals/data.

In some embodiments, the transmitter 1803 independently transmits signals/data, or the processor 1801 controls the transmitter 1803 to transmit signals/data, or the processor 1801 requests the transmitter 1803 to transmit signals/data, or the processor 1801 cooperates with the transmitter 1803 to transmit signals/data.

In some exemplary embodiments of the present disclosure, a computer-readable storage medium is further provided. The computer-readable storage medium stores at least one program. The at least one program, when loaded and run by the processor, causes the processor to perform the positioning method according to the above method embodiments.

In some exemplary embodiments of the present disclosure, a chip is further provided. The chip includes one or more programmable logic circuits and/or one or more program instructions. The chip, when running the one or more programmable logic circuits and/or the one or more program instructions on a communication device, is configured to perform the positioning method according to the above method embodiments.

In some exemplary embodiments of the present disclosure, a computer program product is further provided. The computer program product, when running on a processor of a computer device, causes the computer device to perform the above positioning method.

In some exemplary embodiments of the present disclosure, a computer program is further provided. The computer program includes one or more computer instructions. The one or more computer instructions, when executed by a processor of a computer device, cause the computer device to perform the above positioning method.

Those skilled in the art should be aware that in the one or more examples described above, the functions described in the embodiments of the present disclosure may be implemented using hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely optional embodiments of the present disclosure and are not intended to limit the present disclosure. Any modifications, equivalent substitutions, improvements, or the like, made within the spirit and principle of the present disclosure shall fall within the protection scope of the present disclosure.

1. A positioning method, performed by a first terminal device, the method comprising:
transmitting first information, wherein the first information is used to indicate an entry of the first terminal device into a first area or to request to activate and use first configuration information; and
transmitting a sidelink positioning reference signal (SL-PRS) based on the first configuration information, or performing measurement on an SL-PRS from a second terminal device based on the first configuration information;
wherein the first configuration information is associated with the first area.

2. The method according to claim 1, wherein transmitting the first information comprises:
transmitting the first information to a first device, wherein the first device comprises at least one of a network device or a third terminal device.

3. The method according to claim 2, wherein upon transmission of the first information, the method further comprises:
receiving second information from the first device, wherein the second information is used to instruct the first terminal device to transmit the SL-PRS or perform the measurement on the SL-PRS from the second terminal device.

4. The method according to claim 1, wherein transmitting the first information comprises:
transmitting the first information via unicast, multicast, or broadcast.

5. The method according to claim 4, wherein upon transmission of the first information, the method further comprises:
receiving, from the second terminal device, acknowledgment information fed back for the first information.

6. The method according to claim 1, further comprising:
determining a positioning result of the first terminal device based on a measurement result of the SL-PRS.

7. The method according to claim 6, wherein the measurement result of the SL-PRS is determined by:
the first terminal device; or
the second terminal device.

8. The method according to claim 1, wherein prior to transmitting the first information, the method further comprises:
receiving, from a network device, the first configuration information, wherein the first configuration information comprises a first SL-PRS configuration associated with the first area.

9. The method according to claim 8, wherein the first SL-PRS configuration comprises at least one of:
an SL-PRS radio configuration;
an SL-PRS system frame number (SFN)-level offset;
a new radio-absolute radio frequency channel number (NR-ARFCN);
an SL-PRS resource set identifier (ID);
an SL-PRS resource ID;
an SL-PRS periodicity-and-resource set slot offset;
an SL-PRS resource repetition factor;
an SL-PRS resource time gap;
an SL-PRS symbol number;
an SL-PRS muting option 1;
an SL-PRS muting option 2;
an SL-PRS resource list;
an SL-PRS group comprising at least two SL-PRSs; or
a second terminal device ID associated with the SL-PRS.

10. The method according to claim 9, wherein the SL-PRS radio configuration comprises at least one of:
a subcarrier spacing (SCS);
a resource bandwidth;
a start physical resource block (PRB);
a start position of a start frequency reference point;
a comb size; or
a cyclic prefix.

11. The method according to claim 8, wherein prior to receiving the first configuration information from the network device, the method further comprises:
transmitting, to the network device, an SL-PRS configuration expected, required, or supported by the first terminal device.

12. The method according to claim 1, wherein the first configuration information is associated with a time window corresponding to the first area.

13. The method according to claim 1, wherein transmitting the first information comprises:
transmitting the first information in response to the first terminal device entering the first area from a second area;
wherein the second area is associated with second configuration information.

14. The method according to claim 1, wherein the first area is represented by at least one of:
a radio access network (RAN)-based notification area (RNA);
a tracking area (TA);
a synchronization signal and physical broadcast channel (PBCH) block (SSB); or
a cell.

15. A network device, comprising:
a processor;
a transceiver communicably connected to the processor; and
a memory, configured to store one or more instructions executable by the processor,
wherein the processor is configured to load and execute the one or more instructions to cause the network device to:
receive first information from a first terminal device, wherein the first information is used to indicate an entry of the first terminal device into a first area or to request to activate and use first configuration information;
wherein the first area is associated with the first configuration information.

16. The network device according to claim 15, wherein the processor is further configured to load and execute the one or more instructions to cause the network device to:
transmit third information to a second terminal device, wherein the third information is used to instruct the second terminal device to perform at least one of: initiating transmission of a sidelink positioning reference signal (SL-PRS), initiating reception of an SL-PRS, or initiating measurement on an SL-PRS.

17. The network device according to claim 16, wherein the processor is further configured to load and execute the one or more instructions to cause the network device to:
receive, from the second terminal device, acknowledgment information fed back for the third information.

18. A positioning method, performed by a second terminal device, the method comprising:
receiving trigger information, wherein the trigger information is used to trigger the second terminal device to perform at least one of: initiating transmission of a sidelink positioning reference signal (SL-PRS), initiating reception of an SL-PRS, or initiating measurement on an SL-PRS;
wherein the SL-PRS is transmitted based on first configuration information.

19. The method according to claim 18, wherein:
the trigger information comprises first information used to indicate an entry of a first terminal device into a first area or to request to activate and use the first configuration information;
receiving the trigger information comprises:
receiving the first information from the first terminal device; and
the method further comprises:
performing at least one of: initiating transmission of the SL-PRS, initiating reception of the SL-PRS, or initiating measurement on the SL-PRS.

20. The method according to claim 18, wherein:
the trigger information comprises third information used to instruct the second terminal device to perform at least one of: initiating transmission of the SL-PRS, initiating reception of the SL-PRS, or initiating measurement on the SL-PRS;
receiving the trigger information comprises:
receiving the third information from a first device, wherein the first device comprises at least one of a network device or a third terminal device, and the third information is transmitted based on first information, wherein the first information is used to indicate an entry of a first terminal device into a first area or to request to activate and use the first configuration information; and
the method further comprises:
performing at least one of: initiating transmission of the SL-PRS, initiating reception of the SL-PRS, or initiating measurement on the SL-PRS.
